(19) United States
(12) Patent Application Publication
(10) Pub. No.: US 2012/0234566 A1
(43) Pub. Date: Sep. 20, 2012

(54) IMPACT TOOL

(75) Inventors: Hironori MASHIKO, Ibaraki (JP); Tomomasa NISHIKAWA, Ibaraki (JP); Nobuhiro TAKANO, Ibaraki (JP)

(73) Assignee: HITACHI KOKI CO., LTD.,, Tokyo (JP)

(21) Appl. No.: 13/307,490

(22) Filed: Nov. 30, 2011

(30) Foreign Application Priority Data
Nov. 30, 2010 (JP) 2010-266094
Dec. 29, 2010 (JP) 2010-294377

(51) Int. Cl. B25D 15/00

(52) U.S. Cl. 173/93.5

(57) ABSTRACT

An impact tool including: a motor including, a rotor, a stator, and a detecting device that detects a rotation position of the rotor; a hammer driven by the motor so as to be rotated; an anvil configured to rotate relatively to the hammer and is struck by the hammer; and an output shaft connected to the anvil; wherein the anvil is struck by the hammer by rotating the hammer in a forward rotation direction by a second predetermined amount after rotating the hammer in a reverse rotation direction by a first predetermined amount, and wherein the first predetermined amount and the second predetermined amount are controlled based on a rotation angle that is obtained based on an output of the detecting device.

### CROSS-REFERENCE TO RELATED APPLICATIONS

This application claims priority from Japanese Patent Application No. 2010-266094 filed on Nov. 30, 2010 and from Japanese Patent Application No. 2010-294377 filed on Dec. 29, 2010, the entire contents of which are incorporated herein by reference.

### TECHNICAL FIELD

Aspects of the present invention relate to an impact tool for rotating a tool bit via a speed reducing mechanism. More particularly, the present invention is intended to provide an impact tool capable of efficiently performing striking operation by devising motor drive control and by driving a simple striking mechanism.

### BACKGROUND

An impact tool uses a motor as a drive source to drive a rotary striking mechanism section, thereby exerting a rotational force and a striking force to an anvil and then transmitting a rotational striking force to a tool bit intermittently to perform screw tightening or the like. In recent years, a brushless DC motor has become widely used as a drive source. The brushless DC motor is, for example, a DC (direct current) motor having no brushes (commutation brushes), and coils (windings) are used on its stator side and magnets (permanent magnets) are used on its rotor side. Electric power provided by an inverter circuit is sequentially supplied to the predetermined coils to rotate the rotor. The inverter circuit is formed of large output transistors, such as FETs (field-effect transistors) or IGBTs (insulated gate bipolar transistors) and is driven by a large current. In comparison with a DC motor with brushes, the brushless DC motor is superior in torque characteristics, whereby screws, bolts, etc. can be tightened to secure workpieces with stronger forces.

Related-art discloses an example of an impact tool in which a brushless DC motor is used. According to the related-art, a striking mechanism section of continuously-rotating type is provided. When a rotational force is exerted to a spindle via a drive power transmission mechanism section (speed reducing mechanism section), a hammer engaged so as to be movable in the direction of the rotation axis of the spindle is rotated, whereby an anvil contacting with the hammer is rotated. The hammer and the anvil each have two hammering convex sections (striking sections) disposed mutually symmetric to each other at two positions on a rotation plane. These convex sections are positioned so as to be able to engage with each other in the rotation direction, and a rotational striking force is transmitted by the mutual engagement of the convex sections. The hammer is made slidable in the axial direction with respect to the spindle in a ring area around the spindle, and a cam groove having an inverted V-shape (nearly triangular shape) is provided in the inner circumferential face of the hammer. A V-shaped cam groove is provided in the outer circumferential face of the spindle in the axial direction. The hammer is rotated via a ball (steel ball) inserted between this cam groove and a cam groove provided in the inner circumference of the hammer.

In the related-art drive power transmission mechanism section, the spindle and the hammer are supported via the ball disposed in the cam grooves, and the hammer is configured so as to be movable rearward in the axial direction with respect to the spindle by virtue of a spring disposed behind the hammer. Hence, the number of the components for the spindle and the hammer increases, and since it is required to improve the mounting accuracy between the spindle and the hammer, the production cost becomes high.

Furthermore, in the technology of the related-art, the drive power to be supplied to the motor is constant, regardless of the load condition of the tool bit at the striking time of the hammer. Hence, the striking is performed by using a large tightening torque even in a light load state. This results in supplying excessive electric power to the motor and causing wasteful power consumption.

The present invention is made in view of the above-mentioned background art, and an object thereof is to provide an impact tool configured so as to rotate a tool bit by using a novel striking mechanism and by repeating the forward rotation and reverse rotation of its motor.

Another object of the present invention is to provide an impact tool characterized in that a brushless motor having Hall elements is used as a drive source and that the rotation angle of the hammer rotated until the hammer strikes the anvil is controlled using the output signals of the Hall elements so that the maximum of the reverse rotation stroke of the hammer is securely obtained and so that optimal striking control for outputting a high torque is carried out.

Still another object of the present invention is to provide an impact tool capable of suppressing excessive motor current and reaction by carrying out control in which the supply of electric power for rotating the motor is stopped near the timing when the hammer strikes the anvil.

Still another object of the present invention is to provide an impact tool that performs stable striking operation so that the current rising at the start time of the forward rotation and the reverse rotation of the hammer is suppressed.

Still another object of the present invention is to provide an impact tool configured so as to suppress excessive motor current by ingeniously controlling the duty ratio of PWM control at the start time of the forward rotation and the reverse rotation of the hammer.

### SUMMARY

The characteristics of some of typical aspects of the present invention to be disclosed in this application will be described below.

According to an aspect of the present invention, there is provided an impact tool including: a motor including, a rotor, a stator, and a detecting device that detects a rotation position of the rotor; a hammer driven by the motor so as to be rotated; an anvil configured to rotate relatively to the hammer and is struck by the hammer; and an output shaft connected to the anvil; wherein the anvil is struck by the hammer by rotating the hammer in a forward rotation direction by a second predetermined amount after rotating the hammer in a reverse rotation direction by a first predetermined amount, and wherein the first predetermined amount and the second predetermined amount are controlled based on a rotation angle that is obtained based on an output of the detecting device.

According to another aspect of the present invention, there is provided an impact tool including: a motor; a hammer connected to the motor; an anvil rotated by the hammer; and a control section for controlling rotation of the motor, wherein the hammer strikes the anvil so as to rotate the anvil, and wherein the control section stops supply of a drive voltage to the motor near a timing when the hammer strikes the anvil.

According to another aspect of the present invention, there is provided an impact tool including: a motor; a hammer driven by the motor so as to be rotated; an anvil configured to rotate relatively to the hammer and is struck by the hammer; and an output shaft connected to the anvil, wherein the anvil is struck by the hammer by rotating the hammer in a forward rotation direction by a second predetermined amount after rotating the hammer in a reverse rotation direction by a first predetermined amount, and wherein a duty ratio of pulse-width modulation control is limited during a predetermined period immediately after a rotation direction of the motor is switched to rotate the hammer in the reverse rotation direction or in the forward rotation direction such that the duty ratio of the pulse-width modulation control gradually increases from 0%, and after the duty ratio has reached a limit value, the motor is driven during the predetermined period at a duty ratio of the limited value.

### BRIEF DESCRIPTION OF DRAWINGS

FIG. 1 is a vertical sectional view showing an overall structure of an impact tool 1 according to an exemplary embodiment of the present invention;

FIG. 2 is an enlarged sectional view showing the area around the planetary gear speed reducing mechanism 20 and the striking mechanism 50 shown in FIG. 1;

FIG. 3 is an exploded perspective view showing the shapes of the secondary planetary carrier assembly 51 and the anvil 61 shown in FIG. 1 (part 1);

FIG. 4 is an exploded perspective view showing the shapes of the secondary planetary carrier assembly 51 and the anvil 61 shown in FIG. 1 (part 2);

FIG. 5 (5A, 5B, 5C, 5D, 5E, 5F) is a view showing striking operation between the hammers 52 and 53 and the striking pawls 64 and 65 of the anvil 61 at the cross-section on line A-A of FIG. 2, operation in one revolution being shown in six stages;

FIG. 6 is a functional block diagram showing the drive control system of the motor 3 for the impact tool according to the exemplary embodiment of the present invention;

FIG. 7 (7A, 7B, 7C, 7D) is a view explaining motor control at the time when the impact tool according to the exemplary embodiment of the present invention is operated in an “intermittent drive mode;”

FIG. 8 is a flowchart showing the procedure for controlling the motor of the impact tool according to the exemplary embodiment of the present invention;

FIG. 9 (9A, 9B) is a view showing the waveforms of the detected pulses output from the rotor position detecting circuit 74 and used for the control of the motor 3 and also showing the supply states of the voltages applied to the motor 3 according to the exemplary embodiment of the present invention; and

FIG. 10 (10A, 10B) is a view showing the waveforms of the detected pulses output from the rotor position detecting circuit 74 and used for the control of the motor 3 and also showing the supply states of the voltages applied to the motor 3 according to a second exemplary embodiment of the present invention.

FIG. 11 (11A, 11B, 11C, 11D, 11E) is a view showing the states of motor rotation speed, PWM control duty, striking torque, hammer rotation angle and motor current at the time when the motor 3 is drive-controlled according to a third exemplary embodiment of the invention and

FIG. 12 is a flowchart showing the procedure for controlling the motor of the impact tool 1 according to the third exemplary embodiment of the present invention;

### DETAILED DESCRIPTION

### First Exemplary Embodiment

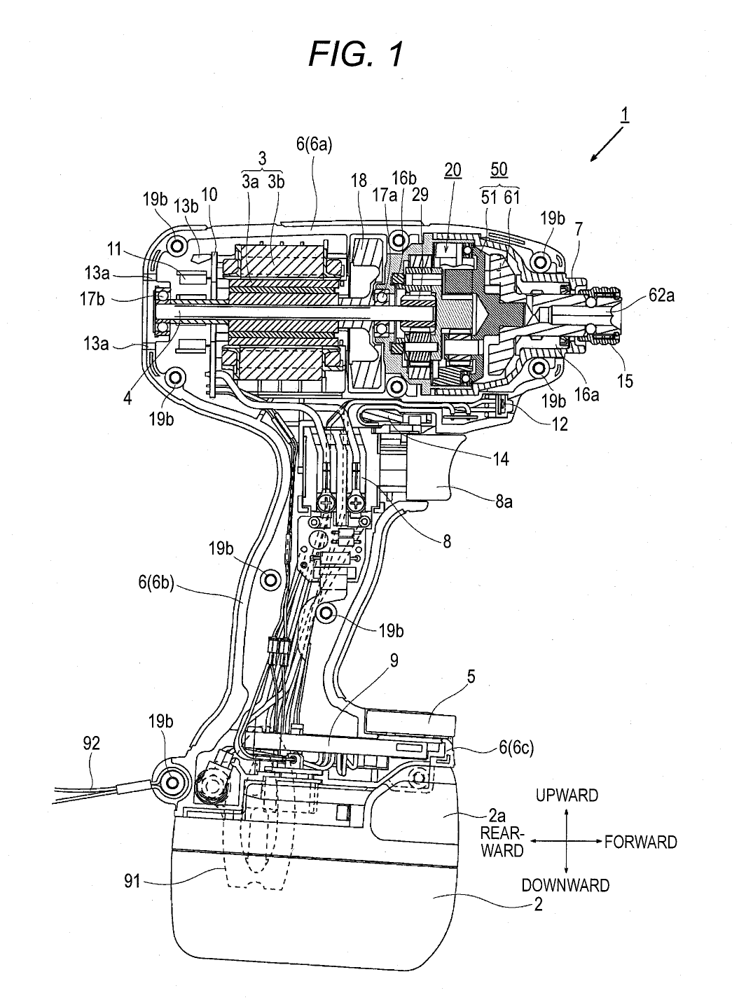

An exemplary embodiment according to the present invention will be described below on the basis of the accompanying drawings. The upward, downward, forward and rearward directions in the following descriptions are defined as the directions indicated in FIG. 1.

FIG. 1 is a vertical sectional view showing an overall structure of an impact tool 1 according to the present invention. In the impact tool 1, a rechargeable battery pack 2 is used as a power source, a motor 3 is used as a drive source to drive an striking mechanism 50, and a rotational force and an striking are exerted to an anvil 61 serving as an output shaft, whereby a continuous rotational force or an intermittent striking force is transmitted to a tool bit, not shown, such as a driver bit, to tighten screws, bolts, etc.

The motor 3, a brushless DC motor, is accommodated inside the nearly cylindrical body section 6a of a housing 6 having a nearly T-shape as viewed from the side so that the axial direction of a rotating shaft 4 is aligned with the front-rear direction. The housing 6 is configured so as to be dividable into two left and right members nearly symmetric with each other, and these members are secured to each other using a plurality of screws, not shown. Hence, a plurality of screw bosses 19b are formed on one member (the left housing member in this exemplary embodiment) of the dividable housing 6, and a plurality of screw holes are formed in the other member, not shown, (the right housing member). The rotating shaft 4 of the motor 3 is rotatably supported by a bearing 17b provided on the rear end side of the body section 6a and by a bearing 17a provided near the central section thereof. An inverter PC board 10 on which six switching devices 11 are mounted is provided behind the motor 3, and inverter control is carried out using these switching devices 11 to rotate the motor 3. Rotation position detecting devices (not shown), such as Hall ICs, for detecting the position of the rotor are mounted on the front side of the inverter PC board 10 and at positions opposed to the permanent magnets of the rotor.

A trigger switch 8, a trigger operation section 8a and a forward/reverse rotation switching lever 14 are provided in the upper section inside a grip section 6b integrally extending downward from the body section 6a of the housing 6 in a nearly perpendicular direction, and a trigger operation section 8a biased by a spring, not shown, so as to protrude from the grip section 6b is provided for the trigger switch 8. An LED 12 is supported at a position below a hammer case 7 connected to the tip end side of the body section 6a. The LED 12 is configured so that when a bit serving as a tool bit, not shown, is inserted into an insertion hole 62a described later, the area around the front end of the bit can be irradiated. A control circuit PC board 9 having a control circuit equipped with functions, such as a function for controlling the speed of the motor 3 depending on the operation of the trigger operation section 8a, is accommodated in the lower section inside the grip section 6b and inside a battery supporting section 6c. A rotary dial switch 5 for setting the operation mode of the impact tool 1 is provided on the front upper side of the control circuit PC board 9 and is installed so that a part or the whole of the dial of the dial switch 5 is exposed externally from the housing 6. With the dial switch 5, a plurality of operation modes can be switched. For example, the operation mode can be switched to a “drill mode (with no clutch mechanism),” a “drill mode (with a clutch mechanism)” or an “impact mode.” In the “impact mode,” it is preferable to use a configuration in which the intensity of a striking torque can be variably set stepwise or continuously. It is desired that a display section, such as a liquid-crystal display section or an LED display section, is provided in a part of the housing 6, and that the display section indicates the mode set using the dial switch 5, although the display section is not shown in FIG. 1.

The battery pack 2 including a plurality of battery cells, such as nickel-hydrogen battery cells or lithium-ion battery cells, is removably mounted on the battery supporting section 6c of the housing 6, the battery supporting section 6c being formed below the grip section 6b. Release buttons 2a are provided for the battery pack 2. The battery pack 2 can be removed from the battery supporting section 6c by moving the battery pack 2 forward while pushing the release buttons 2a provided on both the left and right sides. A strap 92 is attached to the rear side of the battery supporting section 6c. A removable metal belt hook 91 can be removably mounted on either the left or right side of the battery supporting section 6c.

A cooling fan 18 mounted on the rotating shaft 4 so as to rotate in synchronization with the motor 3 is provided ahead of the motor 3. The cooling fan 18 is a centrifugal fan that sucks air around the rotating shaft 4 and exhausts the air externally in the radial direction, regardless of its rotation direction. Air is sucked by the cooling fan 18 from air inlets 13a and 13b provided in the rear section of the body section 6a. The outside air sucked into the housing 6 passes through the clearance between the rotor and the stator of the motor 3 and through the clearances among the magnetic poles of the stator, reaches the cooling fan 18 and is exhausted from a plurality of air outlets (not shown) formed around the radial outer circumferential side of the cooling fan 18 to the outside of the housing 6.

The striking mechanism 50 is formed of two components, an anvil 61 and a secondary planetary carrier assembly 51. The secondary planetary carrier assembly 51 is connected to the rotating shaft of the second-stage planetary gear of a planetary gear speed reducing mechanism 20 and has hammers, described later, for striking the anvil 61. Unlike a known striking mechanism being used widely at present, the striking mechanism 50 is not equipped with a cam mechanism that is formed of a spindle, a spring, a cam groove, a ball, etc. Furthermore, the anvil 61 and the secondary planetary carrier assembly 51 are connected to each other so that only a relative rotation of less than a half revolution can be performed using an insertion shaft and an insertion hole formed near the center of the rotation. The anvil 61 is integrated with the output shaft portion of the impact tool 1 in which a tool bit (not shown) is inserted, and an insertion hole 62a having a hexagonal shape in the cross-sectional plane perpendicular to the axial direction is formed at the front end. However, the anvil 61 and the output shaft into which the tool bit is inserted may be formed of separate components and connected. The rear side of the anvil 61 is connected to the insertion shaft of the secondary planetary carrier assembly 51 and supported so as to be rotatable around the hammer case 7 via a metal 16a at the central area in the axial direction. A sleeve 15 is provided at the tip end of the anvil 61 so that the tool bit can be attached and removed very easily. The detailed shapes of the anvil 61 and the secondary planetary carrier assembly 51 will be described below.

The hammer case 7 is made of a metal and integrally molded to accommodate the striking mechanism 50 and the planetary gear speed reducing mechanism 20 and is installed internally on the front side of the housing 6. The hammer case 7 is used to support the anvil 61 via a bearing mechanism and is secured so as to be covered wholly with the housing 6 that is fabricated in a left-right separation type. Since the hammer case 7 can be supported firmly by the housing 6 as described above, looseness can be prevented from occurring at the bearing portion of the anvil 61, and the service life of the impact tool 1 can be extended.

When the trigger operation section 8a is pulled and the motor 3 is started, the rotation speed of the motor 3 is reduced by the planetary gear speed reducing mechanism 20, and the secondary planetary carrier assembly 51 is rotated at a rotation speed having a predetermined ratio to the rotation speed of the motor 3. When the secondary planetary carrier assembly 51 is rotated, its rotational force is transmitted to the anvil 61 via the hammers provided in the secondary planetary carrier assembly 51, and the anvil 61 starts rotating at the same rotation speed as that of the secondary planetary carrier assembly 51. When the force exerted to the anvil 61 is increased by a reaction force exerted from the tool bit, a control section, described later, detects an increase in the tightening reaction force, changes the drive mode of the secondary planetary carrier assembly 51, and drives the hammers intermittently before the rotation of the motor 3 is stopped and locked.

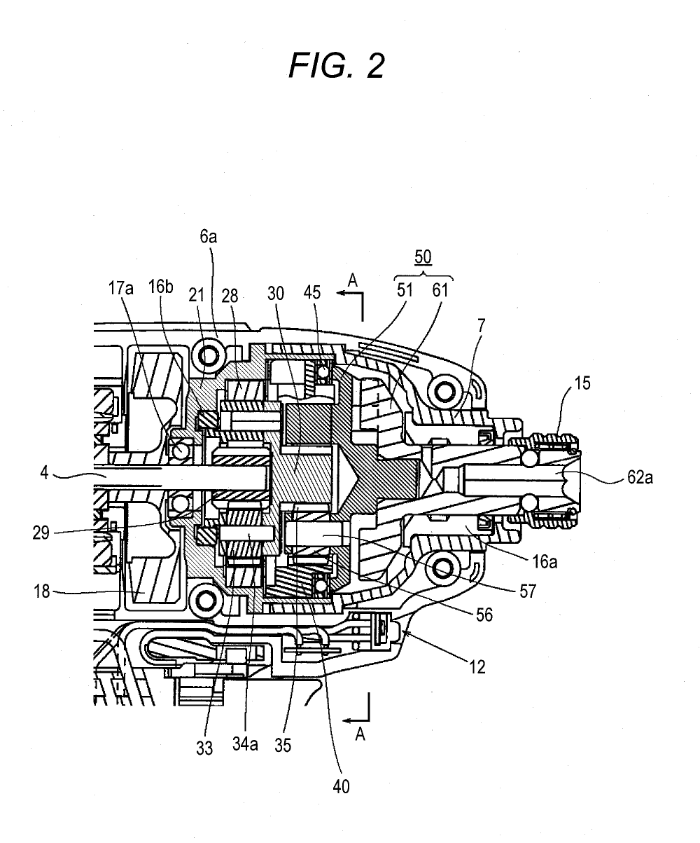

FIG. 2 is an enlarged sectional view showing the area around the striking mechanism 50 shown in FIG. 1. The planetary gear speed reducing mechanism 20 according to the exemplary embodiment is a planetary type, has two speed reducing mechanism sections, a first speed reducing mechanism section and a second speed reducing mechanism section, and each speed reducing mechanism section is formed of a sun gear, a plurality of planetary gears and a ring gear. A first pinion 29 is mounted on the tip end of the rotating shaft 4 of the motor 3, and the first pinion 29 serves as the drive section (input shaft) of the first speed reducing mechanism section. A plurality of first planetary gears 33 are positioned around the first pinion 29 and rotate on the inner circumferential side of a first ring gear 28. Needle pins 34a serving as the rotating shafts of the plurality of first planetary gears 33 are supported by a first planetary gear assembly 30 having the function of a planetary carrier. The first planetary gear assembly 30 serves as the input shaft of the second speed reducing mechanism section, and a second pinion 35 is formed near the front central section thereof.

A plurality of secondary planetary gears 56 are positioned around the second pinion 35 and rotate on the inner circumferential side of the second ring gear 40. Needle pins 57 serving as the rotating shafts of the plurality of secondary planetary gears 56 are supported by the secondary planetary carrier assembly 51. The secondary planetary carrier assembly 51 has the hammers serving as two striking claws corresponding to the striking claws formed on the anvil 61. The secondary planetary carrier assembly 51, serving as the output section of the second speed reducing mechanism section, rotates at a predetermined reduction ratio in the same direction as that of the motor 3. This reduction ratio should only be set properly depending on an object to be tightened mainly (a screw or a bolt), the output of the motor 3, the magnitude of a required tightening torque, etc. In the exemplary embodiment, the reduction ratio is set so that the rotation speed of the secondary planetary carrier assembly 51 is approximately ⅛ to 1/15 of the rotation speed of the motor 3.

An inner cover 21 is provided ahead of the cooling fan 18 inside the body section 6a. The inner cover 21 is made of a synthetic resin, such as plastic, integrally molded, and installed along the inner wall of the housing 6. A cylindrical portion is formed on the rear side of the inner cover 21, and the cylindrical portion supports the outer race of the bearing 17a for rotatably securing the rotating shaft 4 of the motor 3. Furthermore, cylindrical portions having three different diameters are provided stepwise on the front side of the inner cover 21, a cylindrical metal 16b serving as a bearing is provided in the small-diameter portion on the rear side, the first ring gear 28 is inserted into the intermediate-diameter portion at the central area, and the second ring gear 40 and a thrust bearing 45 are accommodated in the large-diameter portion on the front side. In the exemplary embodiment, the rear side of the thrust bearing 45 provided behind the hammers is secured by the second ring gear 40, thereby being supported indirectly by the housing 6. However, without being limited to this configuration, it may be possible to use a configuration in which the rear side is supported by the inner cover 21 or supported directly by the housing 6. In addition to the small-diameter portion, the intermediate-diameter portion and the large-diameter portion, slight step portions for supporting washers and the like described later are formed, but these slight step portions are not described herein. The first ring gear 28 is installed so as to be unrotatable with respect to the inner cover 21, and the second ring gear 40 is installed so as to be able to turn slightly in the radial direction but substantially unrotatable with respect to the inner cover 21. Since the inner cover 21 is installed inside the body section 6a of the housing 6 so as to be unrotatable, the first ring gear 28 and the second ring gear 40 are eventually secured to the housing 6 in an unrotatable state.

The large inner-diameter portion of the inner cover 21 is inserted into the inside through the opening provided on the rear side of the hammer case 7, whereby the planetary gear speed reducing mechanism 20 formed of the first and second speed reducing mechanism sections and the striking mechanism 50 formed of hammers 52 and 53 and the anvil 61 are eventually accommodated inside the space defined by the inner cover 21 and the hammer case 7. Hence, this configuration can effectively prevent grease or the like for lubricating the first and second speed reducing mechanism sections and the striking mechanism from flowing outwardly and can allow the speed reducing mechanism sections and the striking mechanism to operate stably for a long time. In the exemplary embodiment, although no sealing member is placed at the axial joint portion (on the front end side of the inner cover 21 or the rear end side of the hammer case 7) between the inner cover 21 and the hammer case 7, it may be possible to use a configuration in which a sealing member, such as an O-ring, is placed at the portion.

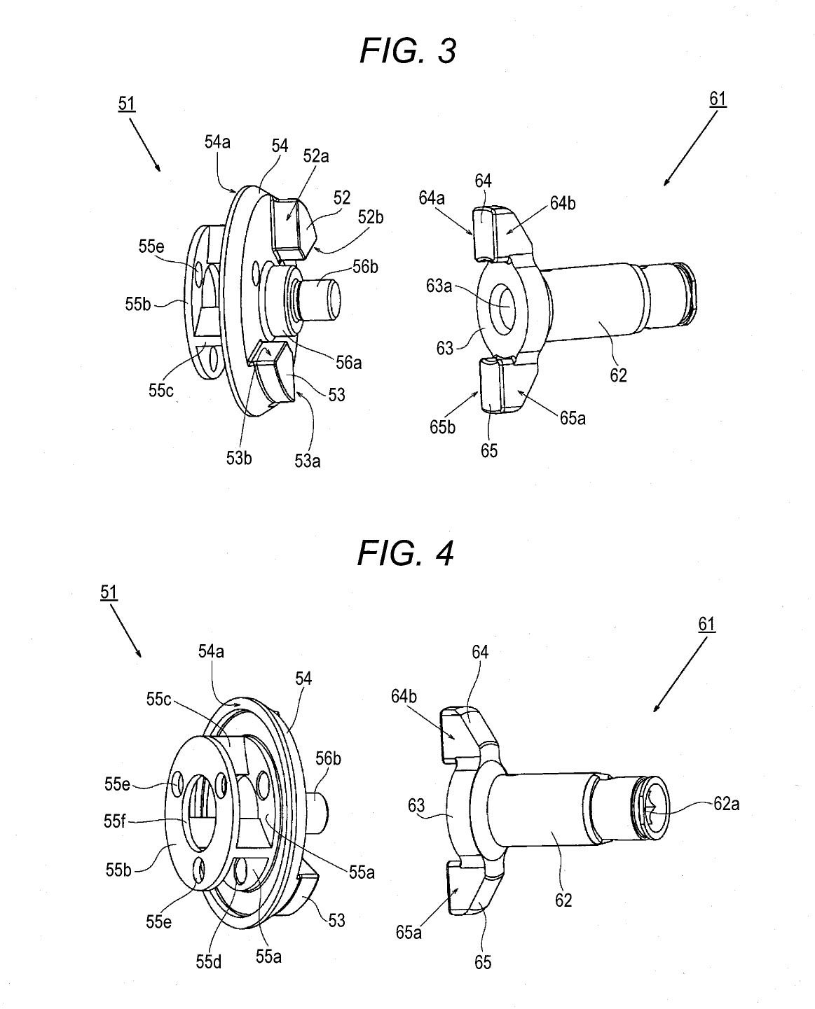

Next, the detailed structures of the secondary planetary carrier assembly 51 and the anvil 61 constituting the striking mechanism 50 will be described below referring to FIGS. 3 and 4. FIG. 3 is a perspective view showing the shapes of the secondary planetary carrier assembly 51 and the anvil 61, the secondary planetary carrier assembly 51 being viewed from an obliquely front side and the anvil 61 being viewed from an obliquely rear side. FIG. 4 is a perspective view showing the shapes of the secondary planetary carrier assembly 51 and the anvil 61, the secondary planetary carrier assembly 51 being viewed from an obliquely rear side and the anvil 61 being viewed from an obliquely front side. In the secondary planetary carrier assembly 51, an integrated disc-shaped member 54 is used as a basic member, and the two hammers 52 and 53 protruding forward in the axial direction are formed at two opposed positions on the disc-shaped member 54. The hammers 52 and 53 function as striking sections (striking claws). Striking faces 52a and 52b are formed in the circumferential direction of the hammer 52, and striking faces 53a and 53b are formed in the circumferential direction of the hammer 53. The striking faces 52a, 52b, 53a and 53b are all formed into a flat face and further formed so as to properly make face contact with the struck faces of the anvil 61 described later. A bumping section 56a and an insertion shaft 56b are formed so as to extend forward from the central axis area of the disc-shaped member 54. A ring-shaped contact face 54a for making contact with the thrust bearing 45 is formed on the rear side of the disc-shaped member 54 near the outer circumference thereof.

On the rear side of the disc-shaped member 54, two disc sections 55a and 55b are formed so as to have the function of the planetary carrier, and connection sections 55c for connecting the disc sections 55a and 55b at three positions in the circumferential direction are formed. Through holes 55d and 55e are respectively formed at three positions in the circumference directions of the disc sections 55a and 55b, three secondary planetary gears 56 (refer to FIG. 2) are disposed between the disc sections 55a and 55b, and the needle pins 57 (refer to FIG. 2) serving as the rotating shafts of the secondary planetary gears 56 are inserted into the through holes 55d and 55e. A circular cut-out hole 55f is formed around the central axis of the disc section 55b on the rear side thereof. The second pinion 35 passes through the cut-out hole 55f and is engaged with the secondary planetary gears 56. The secondary planetary carrier assembly 51 made of a metal and having an integral structure is preferable in strength and weight. Similarly, the anvil 61 made of a metal and having an integral structure is preferable in strength and weight.

In the anvil 61, a disc section 63 is formed on the rear side of a cylindrical output shaft portion 62, and two striking pawls 64 and 65 are formed in the outer circumferential direction of this disc section 63. Struck faces 64a and 64b are formed on both the circumferential sides of the striking pawl 64. Similarly, struck faces 65a and 65b are formed on both the circumferential sides of the striking pawl 65. An insertion hole 63a is formed at the center of the disc section 63, and the insertion shaft 56b is inserted into the insertion hole 63a so as to be connected rotatably, whereby a configuration is obtained in which the secondary planetary carrier assembly 51 and the anvil 61 can rotate relatively to each other on a line being coaxial with and extended from the rotating shaft 4 of the motor 3.

When the secondary planetary carrier assembly 51 rotates in the forward direction (the direction in which a screw or the like is tightened), the striking face 52a contacts with the struck face 64a, and at the same time the striking faces 53a contacts with the struck face 65a. Furthermore, when the secondary planetary carrier assembly 51 rotates in the reverse rotation direction (the direction in which a screw or the like is loosened), the striking faces 52b contacts with the struck face 65b, and at the same time the striking face 53b contacts with the struck face 64b. Since the shapes of the hammers 52 and 53 and the shapes of the striking pawls 64 and 65 are determined so that the above-mentioned contact timings become the same, striking occurs at two positions symmetric with respect to the center of the rotation axis, and a configuration can thus be obtained in which balance at the time of the striking is maintained properly and the impact tool 1 is not swung at the time of the striking.

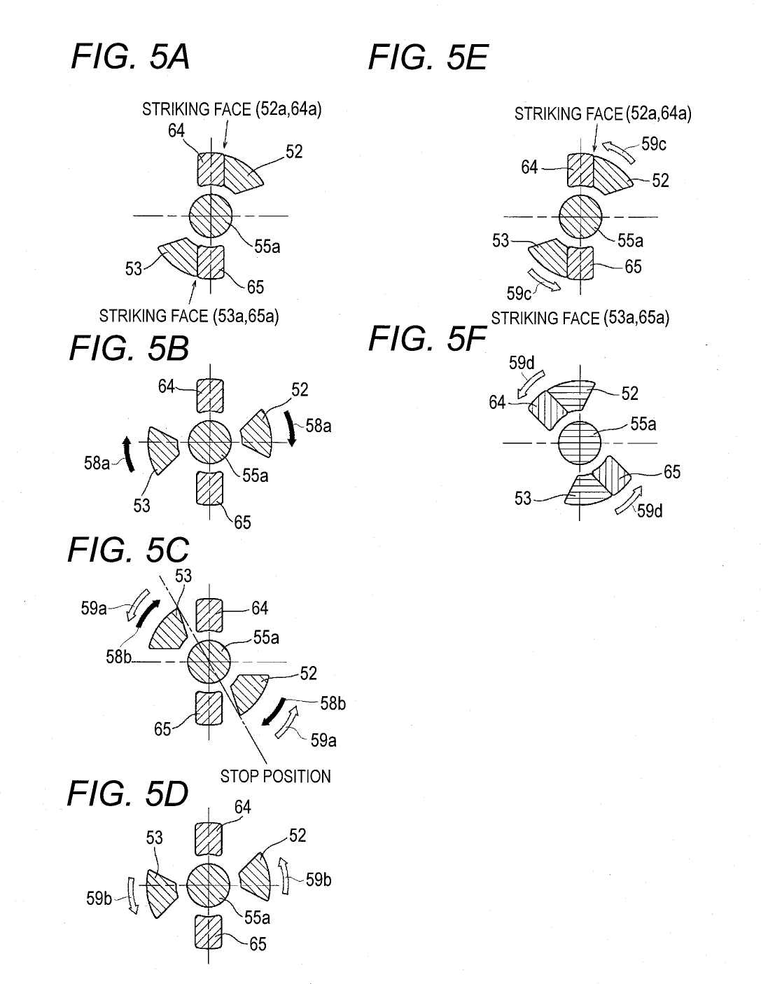

FIG. 5 (5A, 5B, 5C, 5D, 5E, 5F) is a sectional view showing the usage states of the hammers 52 and 53 and the striking pawls 64 and 65 rotated one revolution in six stages. The cross-section in the figure is taken along a plane perpendicular to the axial direction and is taken on line A-A of FIG. 2. In FIG. 5, the hammers 52 and 53 and the disc section 55a rotate integrally (on the drive side), and the striking pawls 64 and 65 also rotate integrally (on the driven side). In the state shown in FIG. 5A, when the tightening torque from the tool bit is small, the striking pawls 64 and 65 are pushed by the hammers 52 and 53 and are rotated counterclockwise. However, in the case that the tightening torque becomes larger and that the striking pawls 64 and 65 cannot be rotated by only the force exerted from the hammers 52 and 53, the reverse rotation of the motor is started to rotate the hammers 52 and 53 in the reverse rotation direction. In the state shown in FIG. 5A, the reverse rotation of the motor is started, and the hammers 52 and 53 are rotated in the direction indicated by arrows 58a as shown in FIG. 5B.

When the motor 3 is rotated in the reverse rotation direction up to a predetermined rotation speed, the driving of the motor 3 is stopped. When the hammers 52 and 53 are further rotated in the reverse rotation direction by inertia and reach the positions (the stop positions in the reverse rotation direction) shown in FIG. 5C and indicated by arrows 58b, that is, when the motor 3 reaches the position shown in FIG. 5C and indicated by arrows 58b, which is a position where the motor 3 has swept back by a predetermined rotation angle (idling angle c′, which will be described later), a drive current is passed through the motor 3 to drive the motor 3 in the forward rotation direction, and the rotation of the hammers 52 and 53 is started in the direction (the forward rotation direction) indicated by arrows 59a. When the hammers 52 and 53 are rotated in the reverse rotation direction, it is important to securely stop the hammers 52 and 53 at predetermined positions so that the hammer 52 does not collide with the striking pawl 65 and so that the hammer 53 does not collide with the striking pawl 64. The stop positions of the hammers 52 and 53 should be set at any desired positions ahead of the positions where the hammers 52 and 53 collide with the striking pawls 64 and 65. However, when the required tightening torque is large, the reverse rotation angle (idling angle c′) thereof should be made larger. The control of the stop positions is carried out using the output signals of the rotation position detecting devices of the motor 3, and the method for the control will be described later.

Then, the hammers 52 and 53 are accelerated in the direction indicated by arrows 59b as shown in FIG. 5D. The striking face 52a of the hammer 52 collides with the struck face 64a of the striking pawl 64 at almost the same time as when supply of the drive voltage is stopped at the position shown in FIG. 5E. At the same time, the striking face 53a of the hammer 53 collides with the struck face 65a of the striking pawl 65. As the result of this collision, a strong rotation torque is transmitted to the striking pawls 64 and 65, and the striking pawls 64 and 65 are rotated in the direction indicated by arrows 59d. At the positions shown in FIG. 5F, the hammers 52 and 53 and the striking pawls 64 and 65 have been rotated by a predetermined angle from the state shown in FIG. 5A. The forward and reverse rotation operations are repeated again from the state shown in FIG. 5A and to the state shown in FIG. 5E, whereby a member to be tightened is tightened until a proper torque is obtained.

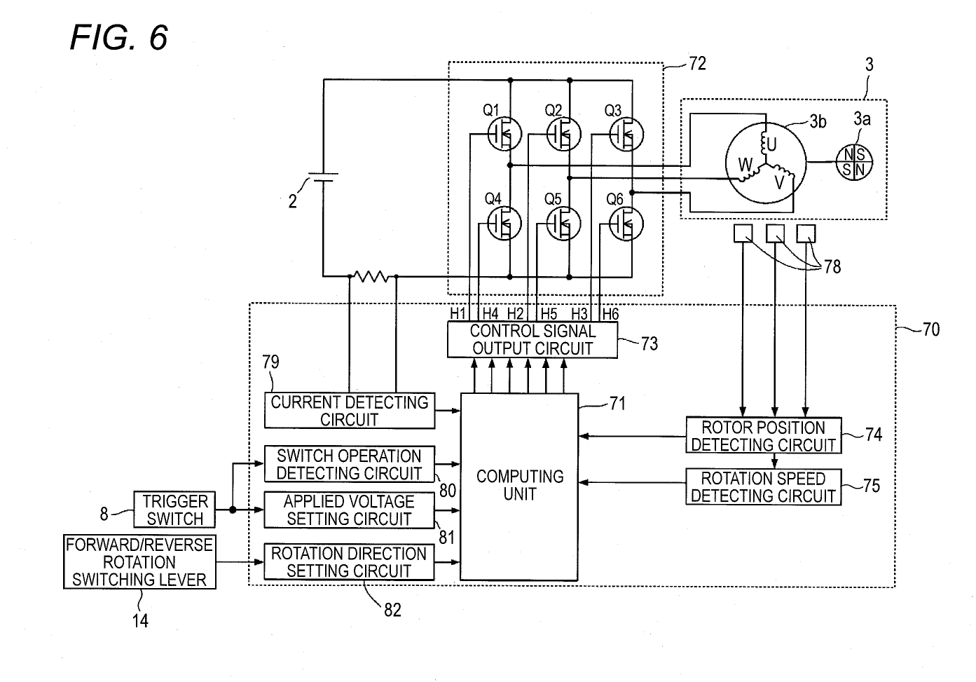

Next, the configuration and action of the drive control system of the motor 3 will be described below on the basis of FIG. 6. FIG. 6 is a block diagram showing the configuration of the drive control system of the motor 3, and the motor 3 according to the exemplary embodiment is formed of a three-phase brushless DC motor. This brushless DC motor is the so-called inner rotor type and has a rotor 3a configured so as to include a plurality of sets (two sets in the exemplary embodiment) of permanent magnets having an N-pole and an S-pole, a stator 3b formed of star-connected three-phase stator windings U, V and W, and three rotation position detecting devices (Hall elements) 78 disposed, for example, at intervals of 60 degrees to detect the rotation position of the rotor 3a. The directions and durations of currents applied to the stator windings U, V and W are controlled on the basis of the position detection signals from the rotation position detecting devices 78, and the motor 3 is rotated.

Six switching devices Q1 to Q6, such as three-phase bridge-connected FETs, are included in the electronic components mounted on the inverter PC board 10. The gates of the six bridge-connected switching devices Q1 to Q6 are connected to a control signal output circuit 73 mounted on the control circuit PC board 9, and the drains or sources of the six switching devices Q1 to Q6 are respectively connected to the star-connected stator windings U, V and W. With this configuration, the six switching devices Q1 to Q6 carry out switching operation depending on the switching device drive signals (drive signals, such as H4, H5 and H6) input from the control signal output circuit 73, whereby the DC voltage of the battery pack 2 applied to an inverter circuit 72 is converted into three-phase (U, V and W phases) voltages Vu, Vv and Vw, and these voltages are applied to the stator windings U, V and W to supply electric power.

Among the switching device drive signals (three-phase signals) for driving the respective gates of the six switching devices Q1 to Q6, the drive signals for driving the respective gates of the three negative power source side switching devices Q4, Q5 and Q6 are supplied as pulse-width modulation signals (PWM signals) H4, H5 and H6. The pulse widths (duty ratios) of the PWM signals are changed on the basis of the detection signal corresponding to the operation amount (stroke) of the trigger operation section 8a of the trigger switch 8 by an computing unit 71 mounted on the control circuit PC board 9, whereby the amount of the electric power supplied to the motor 3 is adjusted, and the start/stop operation and the rotation speed of the motor 3 are controlled.

In this configuration, the PWM signals are supplied to the positive power source side switching devices Q1 to Q3 or the negative power source side switching devices Q4 to Q6 of the inverter circuit 72, and the switching devices Q1 to Q3 or the switching devices Q4 to Q6 are subjected to high-speed switching, whereby the electric power supplied from the battery pack 2 (DC voltage) to the stator windings U, V and W is controlled. In the exemplary embodiment, since the PWM signals are supplied to the negative power source side switching devices Q4 to Q6, the electric power supplied to the respective stator windings U, V and W is adjusted by controlling the pulse widths of the PWM signals. As a result, the rotation speed of the motor 3 can be controlled.

The forward/reverse rotation switching lever 14 for switching the rotation direction of the motor 3 is provided for the impact tool 1. Each time the change of the forward/reverse rotation switching lever 14 is detected, a rotation direction setting circuit 82 switches the rotation direction of the motor 3 and transmits its control signal to the computing unit 71. The computing unit 71 is formed of a central processing unit (CPU) for outputting the drive signals on the basis of processing programs and data, a ROM for storing the processing programs and control data, a RAM for temporarily storing data, a timer, etc. although these are not shown.

The computing unit 71 generates the drive signals for alternately switching the predetermined respective switching devices Q1 to Q6 on the basis of the output signals of the rotation direction setting circuit 82 and a rotor position detecting circuit 74 and outputs the drive signals to the control signal output circuit 73. Hence, energization is performed alternately for the predetermined respective stator windings U, V and W, thereby rotating the rotor 3a in a preset rotation direction. In this case, the drive signals applied to the negative power source side switching devices Q4 to Q6 are output as PWM signals on the basis of the output control signal of an applied voltage setting circuit 81. The value of the current supplied to the motor 3 is measured by a current detecting circuit 79, and the value is fed back to the computing unit 71 and adjusted so that preset drive power is obtained. The PWM signals may be applied to the positive power source side switching devices Q1 to Q3.

Next, a method for driving the impact tool 1 according to the exemplary embodiment will be described below. The impact tool 1 according to the exemplary embodiment is configured so that the anvil 61 and the hammers 52 and 53 can rotate relatively in a rotation angle range of less than 180 degrees. Hence, the hammers 52 and 53 cannot rotate a half revolution or more with respect to the anvil 61, and the control for the rotation becomes special.

In the impact tool 1 according to the exemplary embodiment, when the tightening is carried out in the impact mode, at first, the tightening is carried out in a “continuous drive mode.” When the value of the required tightening torque becomes large, the mode is switched to an “intermittent drive mode” and the tightening is carried out. In the “continuous drive mode,” the computing unit 71 controls the motor 3 on the basis of its target rotation speed. Hence, the motor 3 is accelerated until its rotation speed reaches the target rotation speed, and the anvil 61 is rotated while being pushed by the hammers 52 and 53. When the tightening reaction force from the tool bit installed in the anvil 61 becomes large thereafter, the reaction force transmitted from the anvil 61 to the hammers 52 and 53 becomes large, and the rotation speed of the motor 3 decreases gradually. The decrease in the rotation speed is then detected, and the “intermittent drive mode” is started to rotate the motor 3 in the reverse rotation direction.

The intermittent drive mode is a mode in which the motor 3 is not driven continuously but driven intermittently and the motor 3 is driven pulse-wise so that “forward rotation drive and reverse rotation drive” are repeated multiple times. The expression “driven pulse-wise” in the present specification means that the drive currents supplied to the motor 3 are pulsated by pulsating the gate signals applied to the inverter circuit 72, whereby drive control is carried out to pulsate the rotation speed or output torque of the motor 3. The cycle of the pulsation is approximately several tens of Hz to a hundred and several tens of Hz, for example. A downtime may be provided at the time of the switching between the forward rotation drive and the reverse rotation drive, or the switching may be carried out without downtime. At the time of the drive current ON state, the PWM control is carried out to perform the rotation speed control of the motor 3, however, the cycle of the pulsation is sufficiently smaller than the cycle (usually several kHz) of the duty ratio control in the PWM control.

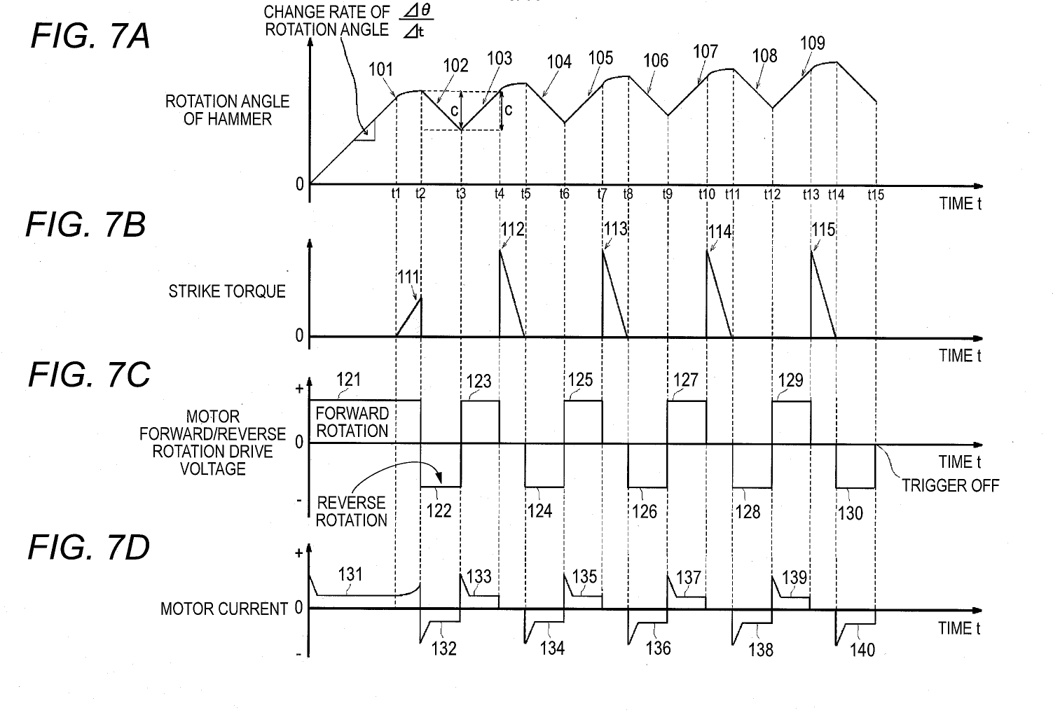

FIG. 7 (7A, 7B, 7C, 7D) is a view explaining motor control at the time when the impact tool 1 according to the present invention is operated in the “intermittent drive mode.” The horizontal axes of the four graphs of FIGS. 7A to 7D represent time t (second) elapsed, and the horizontal axes of the respective graphs are aligned with one another as shown in the figures. In the intermittent drive mode, the hammers 52 and 53 are rotated in the reverse rotation direction by a sufficient relative angle with respect to the anvil 61, then accelerated in the forward rotation direction and made to collide with the anvil 61 vigorously. A strong tightening torque is generated in the anvil 61 by driving the hammers 52 and 53 in the reverse rotation direction and in the forward rotation direction as described above.

FIG. 7A is a graph showing the rotation angle of the hammers 52 and 53, that is, the rotation angle of the secondary planetary carrier assembly 51. The vertical axis represents the rotation angle of the hammers 52 and 53 (unit: rad). When the rotation of the impact tool 1 is started at time 0, the rotation is performed in the “continuous drive mode” from time 0 to time t1. The computing unit 71 periodically obtains the change rate (=Δθ/Δt) of the rotation angle of the hammers 52 and 53 that are rotating in the “continuous drive mode” and monitors the change rate. Since the rotor position detecting circuit 74 outputs pulses detected at predetermined intervals to the computing unit 71 on the basis of the output signals of the rotation position detecting devices 78, the computing unit 71 can calculate the change rate of the rotation angle of the hammers 52 and 53 by monitoring the number of the detected pulses. Since the rotation position detecting devices 78 such as Hall ICs are disposed at intervals of 60 degrees as the rotation angle in the exemplary embodiment, the detected pulses output from the rotor position detecting circuit 74 are output at intervals of 60 degrees as the rotation angle of the rotor 3a. In the exemplary embodiment, the rotation speed of the rotor 3a is reduced by the planetary gear speed reducing mechanism 20 at a predetermined reduction ratio (1:15 in the exemplary embodiment). When it is assumed that the reduction ratio is 1:15, the detected pulses of the rotation position detecting devices 78 are output at intervals of 4 degrees as the rotation angle of the hammers 52 and 53. Hence, in the “intermittent drive mode,” the computing unit 71 can detect the relative rotation angle of the hammers 52 and 53 with respect to the anvil 61 by counting the detected pulses of the rotor position detecting circuit 74.

At time t1 in FIG. 7A, a bolt or the like to be tightened is seated and the change rate of the rotation angle of the hammers 52 and 53 is reduced significantly. At this time, a slight striking torque 111 is generated in the hammers 52 and 53. When the computing unit 71 has detected that the change rate of the rotation angle becomes smaller than a predetermined threshold value during the period from time t1 to time t2, the supply of a forward rotation drive voltage 121 to the motor 3 is stopped, and the supply of a reverse rotation drive voltage 122 is started at time t2. The supply of the reverse rotation drive voltage 122 is performed by transmitting a negative drive signal from the computing unit 71 (refer to FIG. 6) to the control signal output circuit 73 (refer to FIG. 6). The forward rotation and reverse rotation of the motor 3 are accomplished by switching the patterns of the drive signals (ON/OFF signals) output from the control signal output circuit 73 to the switching devices Q1 to Q6. In the rotation drive of the motor 3 using the inverter circuit 72, the voltage to be applied is not changed from a plus value to a minus value, but the order of supplying the drive voltages to the coils is just changed. However, the forward/reverse applied voltages are separated into + and − voltages and represented schematically in FIG. 7C so that the rotation direction of the drive can be easily understood.

The reverse rotation of the motor 3 is started by the supply of the reverse rotation drive voltage 122, whereby the reverse rotation of the hammers 52 and 53 is also started (as indicated by arrow 102). During this reverse rotation, since the hammers 52 and 53 are moved away from the striking pawls 64 and 65 of the anvil 61, the rotation is performed in no load state, whereby the hammers 52 and 53 are rotated significantly in the reverse rotation direction. Next, when the decrease amount of the rotation angle of the hammers 52 and 53 has reached a predetermined threshold value c at time t3, the supply of a forward rotation drive voltage 123 to the motor 3 is started. By the supply of the forward rotation drive voltage 123, the forward rotation of the motor 3 is started again, whereby the forward rotation of the hammers 52 and 53 is also started. At the time of the forward rotation, since the hammers 52 and 53 are moved again to approach the striking pawls 64 and 65 of the anvil 61, the rotation is performed in no load state, and the rotation angle of the hammers 52 and 53 increases significantly (as indicated by arrow 103).

Next, when the increase amount of the rotation angle of the hammers 52 and 53 has reached the threshold value c at time t4, the supply of the forward rotation drive voltage 123 to the motor 3 is stopped. This stop time is close to the time when the rotation speed of the motor 3 reaches the maximum speed. The hammers 52 and 53 collide with the striking pawls 64 and 65 vigorously, and a large striking torque 112 large than the striking torque 111 is generated by this collision. Ideally speaking, the hammers 52 and 53 are supposed to collide with the striking pawls 64 and 65 of the anvil 61 at time t4 when the increase amount has reached the threshold value c. Since the forward rotation drive of the motor 3 is stopped near the timing when the hammers 52 and 53 strike the anvil 61 as described above, the hammers 52 and 53 (the secondary planetary carrier assembly 51) are rotated by inertia at the time of the striking, and the hammers 52 and 53 can strike the anvil 61 by using only the inertia of the secondary planetary carrier assembly 51. As a result, excessive current supply to the motor 3 can be suppressed and efficient striking operation can be achieved. It may be possible that the expression “the time of the striking” means not only the time coincident with the striking time but also a time slightly before the striking time or a time slightly after the striking time. Since the position of the anvil 61 with respect to the hammers 52 and 53 before the striking time is not detected accurately using a dedicated position sensor, it is difficult to accurately control the position. Hence, a state should only be obtained in which the supply of the forward rotation drive voltage 123 to the motor 3 is stopped during a nearly whole period of the period (time t4 to time t5) in which at least the striking torque is generated.

When striking is performed at time t4, the supply of a reverse rotation drive voltage 124 to the motor 3 is started at time t5 when the striking torque disappears, and the reverse rotation of the hammers 52 and 53 is started (as indicated by arrow 104). When the hammers 52 and 53 have been rotated reversely by the threshold value c, the drive voltage of the motor 3 is switched to a forward rotation drive voltage 125. The motor 3 is rotated in the forward rotation direction again by the supply of the forward rotation drive voltage 125 (as indicated by arrow 105). When the increase amount of the rotation angle of the hammers 52 and 53 has reached the threshold value c at time t7, the supply of the forward rotation drive voltage 125 to the motor 3 is stopped. The hammers 52 and 53 collide with the striking pawls 64 and 65 of the anvil 61 at almost the same time as this stop time. Hence, the same control as that carried out during the period from time t4 to time t7 is repeated hereafter. More specifically, the supply of reverse rotation drive voltages 126 and 128 to the motor 3, the supply of forward rotation drive voltages 127 and 129 to the motor 3 and the stop of the supply of the drive voltages to the motor 3 (at time t10 and time t13) are repeated to carry out striking operation, whereby the tightening of a member to be tightened, such as a bolt, is completed. The tightening is ended when the operator releases the trigger switch 8 at time t15. However, the ending of the tightening is not limited to the release operation of the trigger switch 8 by the operator. It may be possible to use a configuration in which a known sensor (not shown) for detecting the tightening torque exerted by the anvil 61 is additionally installed and the computing unit 71 forcibly stops the supply of the drive voltages to the motor 3 when the value of the tightening torque has reached a predetermined value.

FIG. 7D is a graph indicating the magnitude of the current flowing in the motor 3. According to this graph, it can be understood that the current value is large at the portion of the current corresponding to the starting current generated immediately after each of the forward rotation drive voltages 121, 123, . . . is supplied or immediately after each of the reverse rotation drive voltages 122, 124, . . . is supplied.

In the exemplary embodiment, the initial stage of the tightening in which only a small tightening torque is required, the rotation is performed in the continuous drive mode. When the required tightening torque has increased, a screw or a bolt is tightened in the intermittent drive mode. Furthermore, since the rotation angle of the hammers to be rotated in the reverse and forward rotation directions is controlled accurately depending on the rotation angle obtained on the basis of the outputs of the rotation position detecting devices, it is possible to produce an impact tool featuring high efficiency and reduced wasteful power consumption. Furthermore, since the supply of the drive voltage to the motor 3 is stopped near the timing when the hammers 52 and 53 strike the anvil 61 and then the hammers strike the anvil by using only the inertial energy of the hammers, the striking can be performed efficiently. Moreover, the impact tool is effective in that in the case that an object to be tightened is a bolt or nut, the reaction to be transmitted to the hand of the operator after the striking can be decreased.

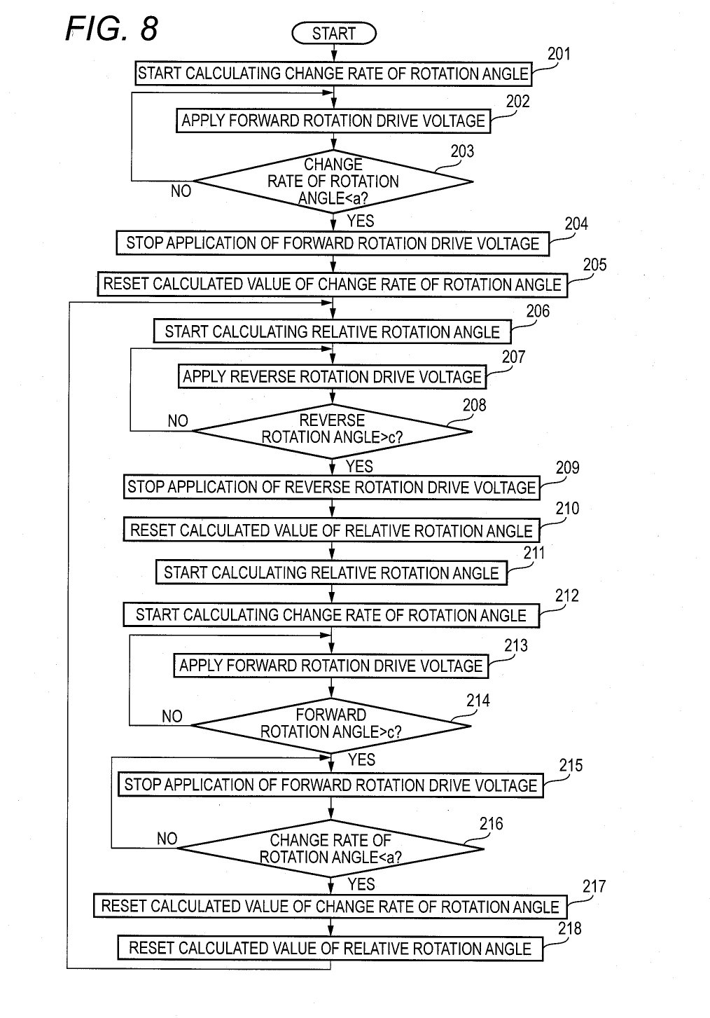

Next, a procedure for controlling the rotation of the motor 3 using the computing unit 71 will be described below referring to the flowchart shown in FIG. 8. The procedure for controlling the rotation shown in the flowchart is started when the trigger switch 8 is pulled. Furthermore, the procedure for controlling the rotation can be accomplished by software by executing programs using a microcomputer, not shown, included in the computing unit 71.

When the trigger switch 8 is pulled, the computing unit 71 starts calculating the change rate (=Δθ/Δt) of the rotation angle of the hammers 52 and 53 and applies the forward rotation drive voltage to the motor 3 at the same time (at steps 201 and 202). Hence, the motor 3 is started in the forward rotation direction, the hammers 52 and 53 and the anvil 61 are rotated integrally, and the tightening of an object to be tightened, such as a bolt, is started. When the object to be tightened is seated on a member to be secured by the object, the change rate of the rotation angle decreases significantly during the period from time t1 to time t2 in FIG. 7A as the load applied thereto increases. Hence, the computing unit 71 judges whether the change rate of the rotation angle calculated in a short cycle has become smaller than a preset threshold value a (at step 203). In the case that the change rate has become smaller, the application of the forward rotation drive voltage to the motor 3 is stopped (at step 204) and the calculated value of the change rate of the rotation angle is reset (at step 205). At step 203, in the case that the change rate of the rotation angle is equal to or more than the threshold value a, the procedure returns to step 202.

Then, the hammers 52 and 53 are rotated reversely (during the period from time t2 to time t3 in FIG. 7A) so as to be ready for the next striking operation. At this time, the calculation of the rotation angle of the hammers 52 and 53 in the reverse rotation direction is started (at steps 206 and 207). Next, a judgment is made as to whether the change rate of the rotation angle has become smaller than the preset threshold value c (at step 208). In the case that the change rate has become larger, the application of the reverse rotation drive voltage is stopped (at steps 208 and 209). The threshold value c is herein set so that the hammers 52 and 53 are separated from the anvil 61 by a sufficient rotation angle, and a sufficient angle value is set as the threshold value c to the extent that no striking is performed in the reverse rotation direction. Furthermore, it is possible to adjust the approach zone of the hammers before the striking depending on the rotation angle in the reverse rotation direction. Hence, the threshold value c should only be set depending on the magnitude of the required striking torque.

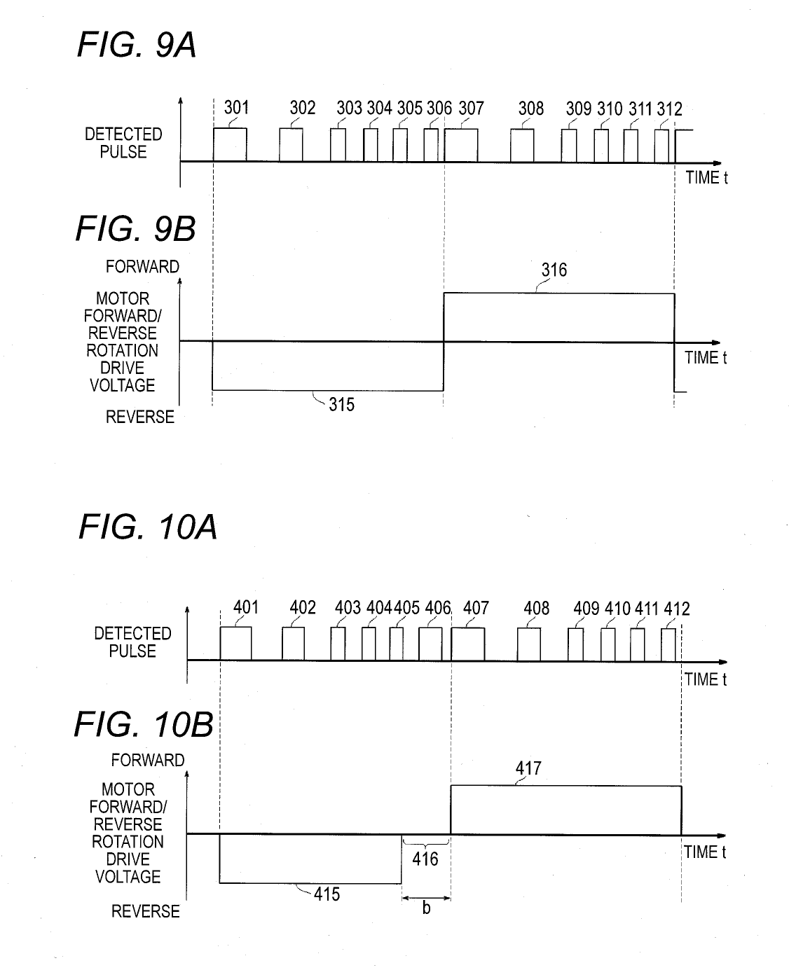

Then, the calculated value of the rotation angle in the reverse rotation direction is reset (at step 210), the calculation of the rotation angle in the forward rotation direction and the calculation of the change rate of the rotation angle of the hammers 52 and 53 are started (at steps 211 and 212), and the forward rotation drive voltage is applied (at step 213). Since the motor 3 starts rotating in the forward rotation direction by the start of the application of the forward rotation drive voltage, the hammers 52 and 53 approach the striking pawls 64 and 65 of the anvil 61. A method for determining the timings of supplying the reverse rotation drive voltage and the forward rotation drive voltage at step 208 and at step 214 will be described below referring to FIG. 9.

FIG. 9 (9A, 9B) is a view showing the waveforms of the detected pulses output from the rotor position detecting circuit 74 and used for the control of the motor 3 and also showing the supply states of the voltages applied to the motor 3. The horizontal axes of the graphs of FIGS. 9A and 9B represent time t, and the two horizontal axes are shown so as to be aligned with each other and so as to have the same timing. The Hall ICs (the rotation position detecting devices 78) for use in the motor 3 according to the exemplary embodiment are disposed at intervals of 60 degrees as the rotation angle. In this case, pulses 301, 302, . . . are each generated each time the rotor 3a of the motor 3 rotates 60 degrees. When it is assumed that the reduction ratio of the planetary gear speed reducing mechanism 20 is 1:15, an angle of 60 degrees as the rotation angle of the rotor 3a corresponds to an angle of 4 degrees as the rotation angle of the hammers 52 and 53.

Hence, in the case that the threshold value c of the rotation angle of the hammers 52 and 53 in the exemplary embodiment is assumed to be approximately 24 degrees, control is carried out so that a reverse rotation drive voltage 315 is supplied during the period in which six pulses 301 to 306 are generated and then a forward rotation drive voltage 316 is supplied during the period in which six pulses 307 to 312 are generated as shown in FIG. 9B. The computing unit 71 can easily judge whether the rotation angle of the hammers 52 and 53 has reached the threshold value c by detecting the detected pulses of the rotation position detecting devices 78 for use in the motor 3 as described above. Although the threshold value c of the rotation angle is set at approximately 24 degrees in the example shown in FIG. 9, the value of the threshold value c can be set as desired. In the case of the shape of the hammers shown in FIGS. 3 and 4, the threshold value c can be set to up to approximately 120 degrees. In the case that the threshold value c is set to 120 degrees, the motor 3 should only be rotated in the reverse rotation direction during a period in which 40 pulses are generated and then the motor 3 should only be rotated in the forward rotation direction during the next period in which 40 pulses are generated. Since the generation of the pulses, such as the pulses 301 to 312, is monitored by the computing unit 71 at all times, the microcomputer of the computing unit 71 can easily control the reverse rotation angle and the forward rotation angle of the hammers 52 and 53.

Referring to FIG. 8 again, in the case that the forward rotation angle has exceeded the threshold value c after the supply of the forward rotation drive voltage at step 213, the supply of the forward rotation drive voltage is stopped (at step 215). At almost the same timing as this stopping timing, the hammers 52 and 53 being accelerated collide with the anvil 61, and a strong striking torque is generated in the forward rotation direction (at time t4 in FIG. 7A). Then, the hammers 52 and 53 rotate integrally with the anvil 61 by virtue of the inertia of the hammers 52 and 53 (during the period from time t4 to time t5 in FIG. 7A).

Next, for the purpose of detecting that the striking by virtue of the inertia of the hammers 52 and 53 is completed (the completion of the rotation), a judgment is made as to whether the change rate of the rotation angle has become smaller than the threshold value a (at step 216). In the case that the change rate of the rotation angle is equal to or more than the threshold value a, the procedure returns to step 215. In the case that the change rate of the rotation angle has become smaller than the threshold value a, the calculated value of the change rate of the rotation angle and the calculated value of the relative rotation angle are reset (at steps 217 and 218), and the procedure returns to step 206 so as to be ready for the next striking operation. The above-mentioned operation is repeated until the operator releases the trigger switch 8. As a result, the tightening of a bolt or the like is completed.

Although the same threshold value (the threshold value a) is used at both steps 216 and 203 in the exemplary embodiment, different threshold values may be set, that is, a threshold value a1 may be set in the continuous drive mode and a threshold value a2 may be set in the intermittent drive mode. Similarly, although the threshold value c1 of the angle of the reverse rotation (reverse rotation angle) is made equal to the threshold value c2 of the angle of the forward rotation (forward rotation angle) at steps 214 and 208, individual threshold values may be used for these.

### Second Exemplary Embodiment

Next, a second exemplary embodiment according to the present invention will be described below referring to FIG. 10 (10A, 10B). Referring to FIG. 10, the second exemplary embodiment is the same as the first exemplary embodiment in that the periods during which a reverse rotation drive voltage 415 and a forward rotation drive voltage 417 are supplied are controlled by using the detected pulses of the rotor position detecting circuit 74, the detected pulses being used for the control in which the rotation angle of the hammers 52 and 53 is used to control the motor 3. However, the second exemplary embodiment is characterized in that a constant rest period 416 (a period in which the supply of the drive voltage to the stator 3b of the motor 3 is stopped) is provided, instead of performing immediately shifting from the supply of the reverse rotation drive voltage 415 to the supply of the forward rotation drive voltage 417.

For the purpose of setting the threshold value c of the rotation angle of the hammers 52 and 53 to approximately 24 degrees, the rotor 3a is required to be rotated in the reverse rotation direction during the period in which six pulses 401 to 406 are generated. However, instead of supplying the reverse rotation drive voltage 415 during the whole period, control is carried out so that the constant rest period 416 is provided immediately before the switching from reverse rotation to forward rotation to hasten the stopping of the supply of the reverse rotation drive voltage 415. During the rest period 416, the motor 3 is rotated by inertia. Then, control is carried out to start the supply of the forward rotation drive voltage 417 at the timing in which a pulse 407 is generated so that the forward rotation drive voltage 417 is supplied to the motor 3 during the period in which six pulses 407 to 412 are generated. In the example shown in FIG. 10, since the rest period 416 having a constant length b is provided immediately before the switching from reverse rotation to forward rotation as described above, the amount of electric power for brake control at the time of the switching from reverse rotation to forward rotation can be reduced, and this can contribute to energy saving.

Although the second exemplary embodiment has been explained by taking an example in which the threshold value c of the rotation angle is approximately 24 degrees, the value of the threshold value c can be set to a desired value. Furthermore, it may be possible to independently set the threshold value c1 of the angle of the reverse rotation (the total of the supply period of the reverse rotation drive voltage 415 and the rest period 416) and the threshold value c2 of the angle of the forward rotation. Moreover, control may be carried out to stop the supply of the forward rotation drive voltage 417 at a time sufficiently before the hammers 52 and 53 strike the anvil 61 (for example, at the time when the pulse 412 is generated as shown in FIG. 10).

### Third Exemplary Embodiment

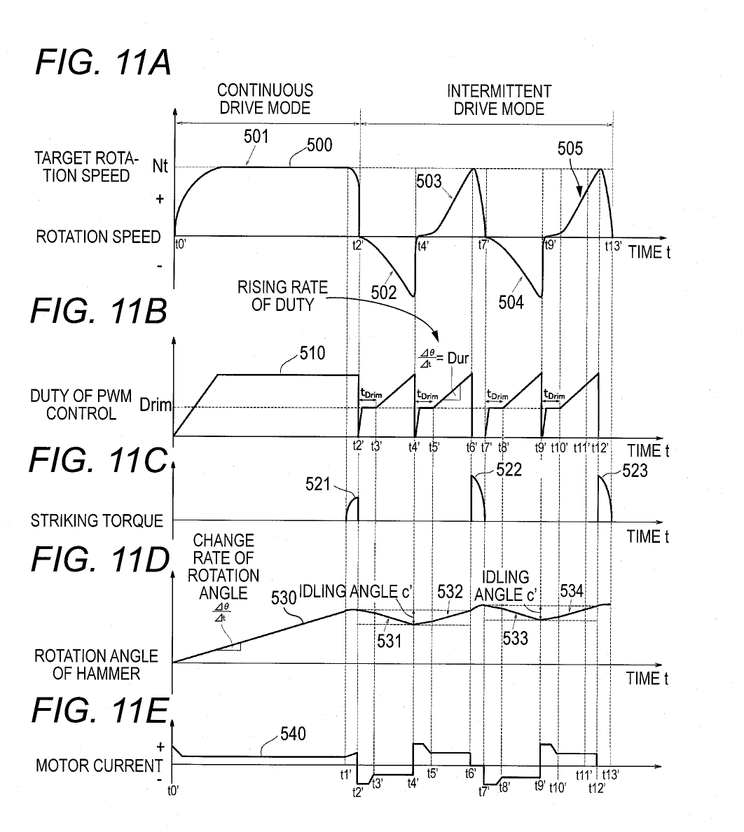

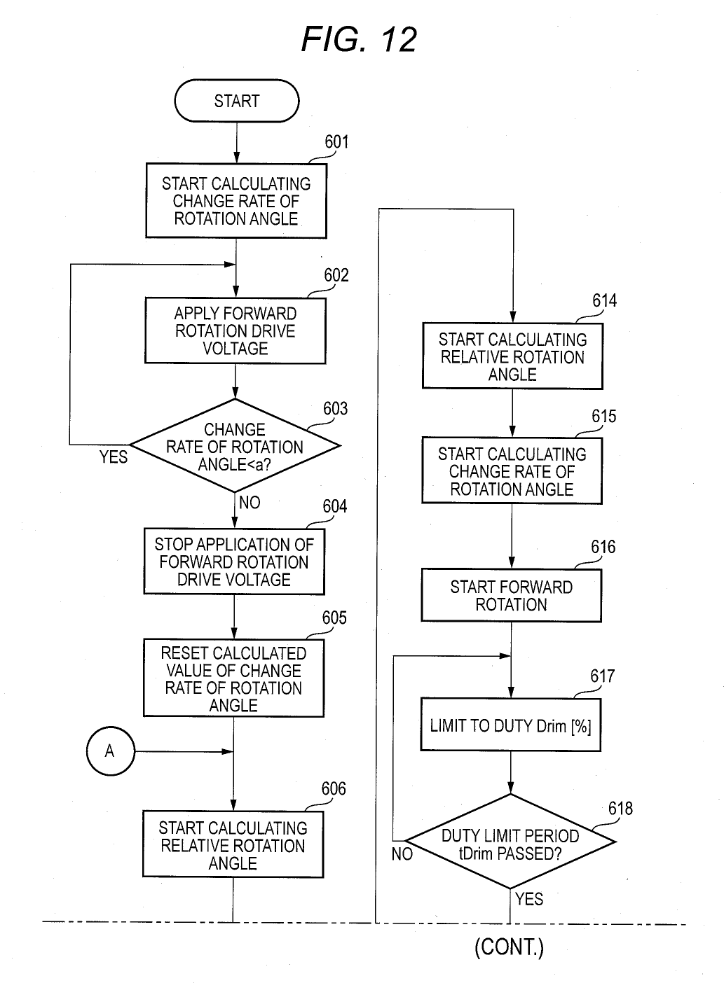

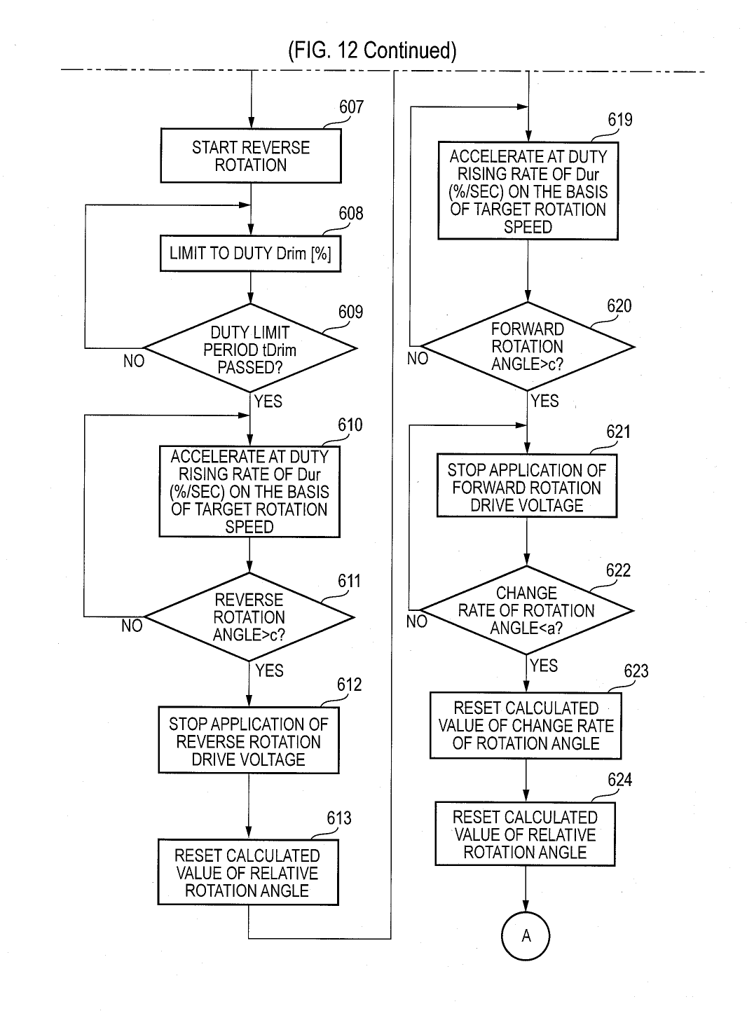

Next, a method for driving the impact tool 1 according to the third exemplary embodiment of the invention will be described below referring to FIGS. 11 and 12. FIG. 11 (11A, 11B, 11C, 11D, 11E) is a view showing the states of motor rotation speed, PWM control duty, striking torque, hammer rotation angle and motor current at the time when the motor 3 is drive-controlled. The horizontal axes of the five graphs of FIGS. 11A to 11E represent time t (second) elapsed, and the horizontal axis scales of the respective graphs are aligned with one another as shown in the figures. The impact tool 1 according to the third exemplary embodiment is configured so that the anvil 61 and the hammers 52 and 53 can rotate relatively in a rotation angle range of less than 180 degrees. Hence, the hammers 52 and 53 cannot rotate a half revolution or more with respect to the anvil 61, and the control for the rotation becomes special.

In the case of the tightening when the “impact mode” is selected as the operation mode of the impact tool 1, the tightening is carried out in a “continuous drive mode” during the period from time t0′ to time t2′ in FIG. 11A. When the value of the required tightening torque becomes large, the mode is switched to an “intermittent drive mode” during the period from time t2′ to time t13′ and the tightening is carried out. In the continuous drive mode, the computing unit 71 controls the motor 3 on the basis of its target rotation speed. Hence, the motor 3 is accelerated until its rotation speed reaches the target rotation speed Nt, and the anvil 61 is rotated while being pushed by the hammers 52 and 53 and united integrally therewith. When the tightening reaction force from the tool bit installed in the anvil 61 becomes large at time t1′ thereafter, the reaction force transmitted from the anvil 61 to the hammers 52 and 53 becomes large, whereby the rotation speed of the motor 3 decreases gradually. The computing unit 71 detects the decrease in the rotation speed of the motor 3 and starts the driving in the intermittent drive mode to rotate the motor 3 in the reverse rotation direction at time t2′.

FIG. 11A is a graph showing the rotation speed 500 of the motor 3. The symbol + in this graph indicates the forward rotation direction (the same direction as the intended rotation direction), and the symbol − indicates the reverse rotation direction (the direction opposite to the intended rotation direction). The vertical axis represents the rotation speed (unit: rpm) of the motor 3. When the trigger operation section 8a is pulled and the motor 3 is started at time t0′, control is carried out so that the motor 3 is accelerated until its rotation speed reaches the target rotation speed Nt and then the motor 3 rotates at a constant speed, that is, the target rotation speed Nt, as indicated by arrow 501.

Then, an object to be tightened, such as a bolt, is seated, the change rate of the rotation angle of the hammers 52 and 53 is reduced significantly, and the rotation speed of the motor 3 decreases gradually. After detecting that the change rate of the rotation angle has become smaller than a predetermined threshold value during the period from time t1 to time t2′, the computing unit 71 stops the supply of a forward rotation drive voltage to the motor 3, and the rotation control for the motor 3 in the “intermittent drive mode” is selected by switching. At time t2′, the supply of a reverse rotation drive voltage to the motor 3 is started. The supply of the reverse rotation drive voltage is carried out by transmitting a negative-going drive signal from the computing unit 71 (referring to FIG. 6) to the control signal output circuit 73 (referring to FIG. 6). The forward rotation and reverse rotation of the motor 3 are accomplished by switching the patterns of the drive signals (ON/OFF signals) output from the control signal output circuit 73 to the switching devices Q1 to Q6. In the rotation drive of the motor 3 using the inverter circuit 72, the voltage to be applied is not changed from a plus value to a minus value, but the order of supplying the drive voltages to the coils is just changed.

The reverse rotation of the motor 3 is started by the supply of the reverse rotation drive voltage, whereby the reverse rotation of the hammers 52 and 53 is also started (as indicated by arrow 502). During this reverse rotation, since the hammers 52 and 53 are moved away from the striking pawls 64 and 65 of the anvil 61, the rotation is performed in no load state, whereby the hammers 52 and 53 are rotated significantly in the reverse rotation direction. Then, the striking operation is performed while the forward rotation and the reverse rotation are repeated. The reverse rotation drive of the motor 3 is performed during the period from time t2′ to time t4′ indicated by arrow 502 and during the period from time t7′ to time t9′ indicated by arrow 504, and the forward rotation drive is performed during the period from time t4′ to time t7′ indicated by arrow 503 and during the period from time t9′ to time t12′ indicated by arrow 505.

FIG. 11B is a graph showing the duty ratio 510 of the PWM control for the motor 3. The predetermined switching devices are driven with a duty ratio of 0 to 100%. In the third exemplary embodiment, the control is carried out not only when the motor 3 is started at time t0′ but also when the motor is started at the time of the switching of the rotation direction, that is, at times t2′, t4′, t7′ and t9′. At times t2′, t4′, t7′ and t9′, the control is carried out so that the duty ratio is increased gradually from 0 to 100%, whereby any unstable control state of the motor 3 due to the control for switching the rotation direction is avoided. Furthermore, in the third exemplary embodiment, after the duty ratio has been increased gradually from 0% to a predetermined ratio, for example, approximately 40%, the duty ratio is limited to a limit value (<100%) only during a predetermined period t_{Drim}. After the predetermined period t_{Drim} has passed, the limit is eliminated, and the duty ratio is increased gradually again up to 100%. It is preferable that the control is carried out so that the increasing rate ΔD/Δt of the duty ratio at this time becomes a predetermined value Dᵤᵣ.

FIG. 11C is a graph showing the striking torque generated when the hammers 52 and 53 strike the anvil 61. Although a weak striking torque 521 is generated during the period (from time t1′ to t2′) in which the rotation speed of the motor driven in the forward rotation direction is decreased, strong striking torques are generated after the hammers 52 and 53 are rotated in the reverse rotation direction and then rotated in the forward rotation direction and when the hammers 52 and 53 strike the anvil 61 at times t6′ and t12′. The waveforms showing these states in the graph correspond to striking torques 522 and 523.

FIG. 11D is a graph showing the rotation angle 530 of the hammers 52 and 53, that is, the rotation angle of the secondary planetary carrier assembly 51. The vertical axis represents the rotation angle (unit: rad) of the hammers 52 and 53. The computing unit 71 periodically obtains the change rate (=Δθ/Δt) of the rotation angle of the hammers 52 and 53 that are rotating in the “continuous drive mode” and monitors the change rate. Since the rotor position detecting circuit 74 outputs pulses detected at predetermined intervals to the computing unit 71 on the basis of the output signals of the rotation position detecting devices 78, the computing unit 71 can calculate the change rate of the rotation angle of the hammers 52 and 53 by monitoring the number of the detected pulses. Since the rotation position detecting devices 78 such as Hall ICs are disposed at intervals of 60 degrees as the rotation angle in the third exemplary embodiment, the detected pulses output from the rotor position detecting circuit 74 are output at intervals of 60 degrees as the rotation angle of the rotor 3a. Furthermore, the rotation speed of the rotor 3a is reduced by the planetary gear speed reducing mechanism 20 at a predetermined reduction ratio (1:15 in the third exemplary embodiment), whereby the detected pulses of the rotation position detecting devices 78 are output at intervals of 4 degrees as the rotation angle of the hammers 52 and 53. Hence, the computing unit 71 can detect the relative rotation angle of the hammers 52 and 53 with respect to the anvil 61 by counting the detected pulses of the rotor position detecting circuit 74.

In the continuous drive mode during the period from t0′ to t1′, since the rotation speed of the motor 3 is almost constant, the change rate of the rotation angle becomes almost constant. During the period from time t2′ to time t4′, the reverse rotation is performed as indicated by arrow 531. When the decrease amount of the rotation angle of the hammers 52 and 53 has reached a predetermined idling angle c′ at time t4′, the supply of a forward rotation drive voltage to the motor 3 is started. By the supply of the forward rotation drive voltage, the forward rotation of the motor 3 is started again, whereby the forward rotation of the hammers 52 and 53 is also started as indicated by arrow 532. At this time of the forward rotation, since the hammers 52 and 53 are moved again to approach the striking pawls 64 and 65 of the anvil 61, the rotation is performed in no load state, and the rotation angle of the hammers 52 and 53 increases significantly.

Next, when the increase amount of the rotation angle of the hammers 52 and 53 has reached the idling angle c′ used as a threshold value at time t6′, the supply of the forward rotation drive voltage to the motor 3 is stopped. This stop time is close to the time when the rotation speed of the motor 3 reaches the maximum speed. The hammers 52 and 53 collide with the striking pawls 64 and 65 vigorously, and a large striking torque 522 large than the striking torque 521 is generated by this collision. Ideally speaking, the hammers 52 and 53 are supposed to collide with the striking pawls 64 and 65 of the anvil 61 at time t6 when the increase amount has reached the idling angle c′. Since the forward rotation drive of the motor 3 is stopped near the timing when the hammers 52 and 53 strike the anvil 61 as described above, the hammers 52 and 53 (the secondary planetary carrier assembly 51) are rotated by inertia at the time of the striking, and the hammers 52 and 53 can strike the anvil 61 by using only the inertia of the secondary planetary carrier assembly 51. As a result, excessive current supply to the motor 3 can be suppressed and efficient striking operation can be achieved. It may be possible that the expression “the time of the striking” means not only the time coincident with the striking time but also a time slightly before the striking time or a time slightly after the striking time. Since the position of the anvil 61 with respect to the hammers 52 and 53 before the striking time is not detected accurately using a dedicated position sensor, it is difficult to accurately control the position. Hence, a state should only be obtained in which the supply of the forward rotation drive voltage to the motor 3 is stopped during a nearly whole period of the period (from time t6′ to time t7′) in which at least the striking torque is generated.

When striking is performed at time t6′, the supply of a reverse rotation drive voltage to the motor 3 is started at time t7′ when the striking torque disappears, and the reverse rotation of the hammers 52 and 53 is started (as indicated by arrow 504). When the hammers 52 and 53 have been rotated reversely by the idling angle c′, the drive voltage of the motor 3 is switched to a forward rotation drive voltage. The motor 3 is rotated in the forward rotation direction again by the supply of the forward rotation drive voltage (as indicated by arrow 534). When the increase amount of the rotation angle of the hammers 52 and 53 has reached the idling angle c′ at time t12′, the supply of the forward rotation drive voltage to the motor 3 is stopped. The hammers 52 and 53 collide with the striking pawls 64 and 65 of the anvil 61 at almost the same time as this stop time. Hence, the same control as that carried out during the period from time t2′ to time t7′ is repeated hereafter. More specifically, the supply of reverse rotation drive voltages to the motor 3, the supply of forward rotation drive voltages to the motor 3 and the stop of the supply of the drive voltages to the motor 3 (during the period from time t12′ to time t13′) are repeated to carry out striking operation, whereby the tightening of a member to be tightened, such as a bolt, is completed. The tightening is ended when the operator releases the trigger operation section 8a at time t13′. However, the ending of the tightening is not limited to the release operation of the trigger operation section 8a by the operator. It may be possible to use a configuration in which a known sensor (not shown) for detecting the tightening torque exerted by the anvil 61 is additionally installed and the computing unit 71 forcibly stops the supply of the drive voltage to the motor 3 when the value of the tightening torque has reached a predetermined value.

FIG. 11E is a graph showing the current value 540 flowing through the motor 3 and detected by a current detecting circuit 79. Generally speaking, the rush current that occurs when the motor 3 is started becomes large and sometimes exceeds ten times the current value obtained during constant-speed rotation. Hence, a countermeasure, such as gradually raising the duty ratio from a low value, is usually taken to decrease the rush current at the time of the start. However, with the control according to the third exemplary embodiment, it is possible to limit the currents during the period from time t2′ to time t3′, during the period from time t4′ to time t5′, during the period from time t7′ to time t8′, and during the period from time t9′ to time t10′. Although the current values detected by the current detecting circuit 79 do not become + and − values in the rotation control of the motor 3 using the inverter circuit 72, it is assumed that the current that flows when the motor 3 is rotated in the forward rotation direction has a plus current value and that the current that flows when the motor 3 is rotated in the reverse rotation direction has a minus current value, for the convenience of description.

As described above, in the third exemplary embodiment, at the initial stage of the tightening in which only a small tightening torque is required, the rotation is performed in the continuous drive mode. When the required tightening torque has increased, a screw or a bolt is tightened in the intermittent drive mode, whereby the tightening can be performed efficiently and quickly. Furthermore, since the rotation angle of the hammers to be rotated in the reverse and forward rotation directions is controlled accurately depending on the rotation angle obtained on the basis of the outputs of the rotation position detecting devices, it is possible to produce an impact tool featuring reduced wasteful power consumption. Furthermore, since the supply of the drive voltage to the motor 3 is stopped near the timing when the hammers 52 and 53 strike the anvil 61 and then the hammers strike the anvil by using only the inertial energy of the hammers, the impact tool is effective in that the reaction to be transmitted to the hand of the operator after the striking can be decreased.

Next, a procedure for controlling the rotation of the motor 3 using the computing unit 71 will be described below referring to the flowchart shown in FIG. 12. The procedure for controlling the rotation shown in the flowchart is started when the trigger operation section 8a is pulled. Furthermore, the procedure for controlling the rotation can be accomplished by software by executing programs using a microcomputer, not shown, included in the computing unit 71.

When the trigger operation section 8a is pulled, the computing unit 71 starts calculating the change rate (=Δθ/Δt) of the rotation angle of the hammers 52 and 53 (at step 601) and applies the forward rotation drive voltage to the motor 3 at a predetermined duty ratio (at step 602). Hence, the motor 3 is started in the forward rotation direction, the hammers 52 and 53 and the anvil 61 are rotated integrally, and the tightening of a bolt or the like is started.

The computing unit 71 judges whether the change rate Δθ/Δt of the rotation angle of the motor 3 calculated in a short cycle has become smaller than a preset threshold value a (at step 603). The change rate Δθ/Δt of the rotation angle becomes smaller than the threshold value a when an object to be tightened is in a state of being seated on a member to be secured by the object (the state obtained during the period from time t1′ to time t2′ in FIG. 11A). Hence, the computing unit 71 stops the application of the forward rotation drive voltage to the motor 3 (at step 604) and resets the calculated value of the change rate of the rotation angle (at step 605). At step 603, in the case that the change rate of the rotation angle is equal to or more than the threshold value a, the procedure returns to step 602.

Then, the calculation of the relative rotation angle of the hammers 52 and 53 in the reverse rotation direction is started (at step 606) and the reverse rotation of the motor 3 is started to rotate the hammers 52 and 53 in the reverse rotation direction (at step 607) so as to be ready for the next striking operation. At this time, the duty ratio is increased gradually from 0 to 100%. However, the upper limit of the duty ratio is set to Drim (%) during only the predetermined period t_{Drim} after the start of the reverse rotation of the motor 3 (at step 608). The upper limit Drim used as a threshold value should only be set to the range from approximately 10 to 70%, for example. In the third exemplary embodiment, Drim is set to 40%.

Next, a judgment is made as to whether the period t_{Drim} in which the duty ratio is limited has passed (at step 609). In the case that the period has not passed, the procedure returns to step 608. In the case that the period t_{Drim} has passed, the limitation of the duty ratio is eliminated, and the duty ratio is raised to 100% at a rising rate of Dᵤᵣ (%/sec) (at step 610) on the basis of the target rotation speed.

Next, a judgment is made as to whether the reverse rotation angle of the hammers 52 and 53 has reached a predetermined angle (the idling angle c′) or more (at step 611). In the case that the reverse rotation angle has not reached the idling angle c′, the procedure returns to step 610. In the case that the reverse rotation angle has become equal to or more than the idling angle c′, the control section 70 stops the application of the reverse rotation drive voltage to the motor 3 (at step 612). The idling angle c′ is herein set so that the hammers 52 and 53 are separated from the anvil 61 by a sufficient rotation angle, and a sufficient angle value is set as the idling angle c′ to the extent that no striking is performed in the reverse rotation direction. Furthermore, it is possible to adjust the approach zone of the hammers before the striking depending on the rotation angle in the reverse rotation direction. Hence, the idling angle c′ should only be set depending on the magnitude of the required striking torque.

Then, the calculated value of the relative rotation angle in the reverse rotation direction is reset (at step 613), the calculation of the relative rotation angle in the forward rotation direction and the calculation of the change rate of the rotation angle of the hammers 52 and 53 are started (at steps 614 and 615), and the forward rotation drive voltage is applied, thereby starting the forward rotation of the motor 3 (at step 616). At this time, the duty ratio is increased gradually from 0 to 100%. However, the upper limit of the duty ratio is set to Drim (%) only during the predetermined period t_{Drim} after the start of the forward rotation of the hammers 52 and 53 (at step 617). Drim should only be set appropriately in the range of approximately 10 to 50%, for example. In the third exemplary embodiment, Drim is set to 40%, the same value as in the case of the reverse rotation.

Next, a judgment is made as to whether the period t_{Drim} in which the duty ratio is limited has passed (at step 618). In the case that the period has not passed, the procedure returns to step 617. In the case that the period t_{Drim} has passed, the limitation of the duty ratio is eliminated, and the duty ratio is raised to 100% at the rising rate of D (%/sec) (at step 619) on the basis of the target rotation speed.

Next, a judgment is made as to whether the forward rotation angle of the hammers 52 and 53 has reached the predetermined angle (the idling angle c′) or more (at step 620). In the case that the forward rotation angle has not reached the idling angle c′, the procedure returns to step 619. In the case that the forward rotation angle has become equal to or more than the idling angle c′, the control section 70 stops the application of the forward rotation drive voltage to the motor 3 (at step 621). At almost the same timing as this stopping timing, the hammers 52 and 53 being accelerated collide with the anvil 61, and a strong striking torque is generated in the forward rotation direction (at time t6′ in FIG. 11). Then, the hammers 52 and 53 rotate integrally with the anvil 61 by virtue of the inertia of the hammers 52 and 53 (during the period from time t6′ to time t7′ in FIG. 11).

Next, for the purpose of detecting that the striking by virtue of the inertia of the hammers 52 and 53 is completed (the completion of the rotation), a judgment is made as to whether the change rate of the rotation angle has become smaller than the threshold value a (at step 622). In the case that the change rate of the rotation angle is equal to or more than the threshold value a, the procedure returns to step 621. In the case that the change rate of the rotation angle has become smaller than the threshold value a, the calculated value of the change rate of the rotation angle and the calculated value of the relative rotation angle are reset (at steps 623 and 624), and the procedure returns to step 606 so as to be ready for the next striking operation. The above-mentioned operation is repeated until the operator releases the trigger operation section 8a. The tightening of a bolt or the like is completed by the release operation.

Although the idling angle of the angle of the reverse rotation (reverse rotation angle) is made equal to the idling angle of the angle of the forward rotation (forward rotation angle) at steps 611 and 620 in the third exemplary embodiment, individual threshold values may be used for these. Furthermore, although the amounts of the reverse rotation and the forward rotation are determined by the rotation angle of the hammers 52 and 53 in the exemplary embodiment, without being limited to this, the amounts may be determined by the reverse rotation time or the forward rotation time thereof. Even in this case, a configuration should only be used in which the duty ratio of the PWM control is limited to Drim only during a predetermined period immediately after the rotation direction of the motor is switched.

Although the present invention has been described above on the basis of the exemplary embodiments thereof, the present invention is not limited to the above-mentioned exemplary embodiments, but can be modified variously within a range not departing from the gist thereof. For example, the shapes of the anvil and the hammers are arbitrary. More specifically, the anvil and the hammers may have shapes other than the above-mentioned shapes, provided that the anvil and the hammers have structures characterized in that the anvil and the hammers cannot continuously rotate relative to each other (so that they cannot rotate while climbing over each other) and that the striking face and the struck face thereof are formed while a predetermined relative rotation angle of less than 180 degrees or less than 360 degrees is securely obtained. Moreover, although the control to be carried out when a bolt is tightened has been described in the above-mentioned exemplary embodiments, the control can also be applied similarly when a wood screw or the like is tightened and loosened (removed).

Still further, the present invention can also be applied similarly to an impact tool in which the rotation of the motor thereof is not switched between forward rotation and reverse rotation, provided that the hammers strike the anvil to rotate the anvil. Power consumption is reduced by stopping the supply of the drive voltage to the motor near the timing when the hammers strike the anvil even in the case that the hammers are rotated continuously in the forward rotation direction.

The present invention provides illustrative, non-limiting aspects as follows:

(1) In a first aspect, there is provided An impact tool including: a motor including, a rotor, a stator, and a detecting device that detects a rotation position of the rotor; a hammer driven by the motor so as to be rotated; an anvil configured to rotate relatively to the hammer and is struck by the hammer; and an output shaft connected to the anvil; wherein the anvil is struck by the hammer by rotating the hammer in a forward rotation direction by a second predetermined amount after rotating the hammer in a reverse rotation direction by a first predetermined amount, and wherein the first predetermined amount and the second predetermined amount are controlled based on a rotation angle that is obtained based on an output of the detecting device.

According the first aspect, in the impact tool characterized in that the hammer strikes the anvil to rotate the anvil while the hammer is rotated alternately in the forward rotation direction and the reverse rotation direction, the first predetermined rotation amount and the second predetermined rotation amount of the hammer that is rotated in the reverse rotation direction and in the forward rotation direction is controlled based on the rotation angle obtained based on the output of the rotation position detecting device. Hence, almost the whole stroke (movable range) in which it is possible to perform the relative rotation between the hammer and the anvil can be used for reverse rotation and acceleration, whereby the acceleration period of the hammer can be made large. For this reason, the inertial energy of the hammer can be made large, and the striking torque obtained from the output shaft can also be made large.

(2) In a second aspect, there is provided the impact tool according to the first aspect, further including a control section for controlling the rotation of the motor, wherein the control section starts an intermittent drive control, in which the hammer is rotated in the reverse rotation direction and in the forward rotation direction, after a change rate of the rotation angle of the hammer that is continuously driven in the forward rotation direction becomes less than a predetermined value.

According to the second aspect, at the time of a low load state before a bolt or the like is seated, the anvil is rotated continuously, whereby an object to be tightened can be tightened quickly. Furthermore, since the seating state can be detected with a high degree of accuracy, the continuous drive control can be quickly shifted to the intermittent drive control.

(3) In a third aspect, there is provided the impact tool according to the second aspect, wherein the control section stores a reverse rotation start position of the hammer, which is a position where the hammer starts the reverse rotation, rotates the hammer in the reverse rotation direction and then in the forward rotation direction, and stops supply of a forward rotation drive voltage to the motor after the hammer has reached an area near the reverse rotation start position again.

According to the third aspect, only the inertial energy of the hammer is used to strike the anvil, whereby the striking can be made efficiently. If the hammer rotates continuously in the forward rotation direction after the hammer has reached the reverse rotation start position, the anvil is driven by not only the inertial energy of the hammer but also the rotation output from the motor, whereby, energy loss becomes large.

(4) In a fourth aspect, there is provided the impact tool according to the third aspect, wherein a reverse rotation angle and a forward rotation angle of the rotor are calculated in order to detect that the hammer has reached the area near the reverse rotation start position.

According to the fourth aspect, the rotation position of the hammer can be detected accurately using the outputs of the existing rotation position detecting device without additionally providing rotation position detecting means for the hammer.

(5) In a fifth aspect, there is provided the impact tool according to any one of the first to fourth aspects, wherein the hammer is connected to the motor via a speed reducing mechanism, and wherein a forward rotation angle and a reverse rotation angle of the hammer are calculated by multiplying the rotation angle of the motor by a reduction ratio of the speed reducing mechanism.

According to the fifth aspect, the rotation position of the hammer can be detected at accuracy far higher than the rotation angle detection accuracy of the rotor.

(6) In a sixth aspect, there is provided an impact tool including: a motor; a hammer connected to the motor; an anvil rotated by the hammer; and a control section for controlling rotation of the motor, wherein the hammer strikes the anvil so as to rotate the anvil, and wherein the control section stops supply of a drive voltage to the motor near a timing when the hammer strikes the anvil.

According to the sixth aspect, in the impact tool that uses the hammer that strikes the anvil so as to rotate the anvil, the control section stops supply of a drive voltage to the motor near a timing when the hammer strikes the anvil, whereby the hammer can strike the anvil using only the inertial energy of the hammer. As a result, effective striking can be performed.

(7) In a seventh aspect, there is provided the impact tool according to the sixth aspect, wherein the control section causes the hammer to strike the anvil and to rotate the anvil by rotating the hammer alternately in a forward rotation direction and in a reverse rotation direction.

According to the seventh aspect, the stroke in which it is possible to perform the relative rotation between the hammer and the anvil can be used for reverse rotation and acceleration, and the acceleration period of the hammer can be made large and the striking torque obtained from the output shaft can also be made large.

(8) In an eighth aspect, there is provided the impact tool according to the seventh aspect, wherein, before the hammer strikes the anvil, the motor is rotated by inertia.

According to the eighth aspect, it is possible to securely prevent the anvil from being driven by the rotation output of the motor. As a result, the reaction transmitted to the housing of the impact tool at the time of the striking can be suppressed and the loss in electric energy can be reduced.

(9) In a ninth aspect, there is provided the impact tool according to the seventh aspect, wherein the supply of the drive voltage to the motor is stopped when the hammer strikes the anvil.

According to the ninth aspect, the reaction transmitted to the housing of the impact tool at the time of the striking can be suppressed and the loss in electric energy can be reduced.

(10) In a tenth aspect, there is provided the impact tool according to the eighth or ninth aspect, wherein the rotation angle of the hammer is detected by using an output of a sensor for detecting a rotation position of the motor, and wherein the hammer is controlled to be rotated in the forward rotation direction by an angle equal to or slightly less than a predetermined angle after the hammer has been rotated in the reverse rotation direction by the predetermined angle.

According to the tenth aspect, the supply of the drive voltage to the motor can be stopped securely at the time of the striking.

(11) In an eleventh aspect, there is provided the impact tool according to the tenth aspect, wherein the motor is connected to the hammer via gears, and a rotation speed of the motor is higher than a rotation speed of the hammer.

According to the eleventh aspect, a large output torque is obtained even if the motor is small. In addition, the rotation position of the hammer can be detected at accuracy far higher than the rotation accuracy of the rotor of the motor.

(12) In a twelfth aspect, there is provided an impact tool including: a motor; a hammer driven by the motor so as to be rotated; an anvil configured to rotate relatively to the hammer and is struck by the hammer; and an output shaft connected to the anvil, wherein the anvil is struck by the hammer by rotating the hammer in a forward rotation direction by a second predetermined amount after rotating the hammer in a reverse rotation direction by a first predetermined amount, and wherein a duty ratio of pulse-width modulation control is limited during a predetermined period immediately after a rotation direction of the motor is switched to rotate the hammer in the reverse rotation direction or in the forward rotation direction such that the duty ratio of the pulse-width modulation control gradually increases from 0%, and after the duty ratio has reached a limit value, the motor is driven during the predetermined period at a duty ratio of the limited value.

According to the twelfth aspect, in the impact tool characterized in that the hammer strikes the anvil to rotate the anvil while the hammer is rotated alternately in the forward rotation direction and the reverse rotation direction, the duty ratio of the PWM control is limited during the predetermined period immediately after the rotation direction of the motor is switched. Hence, excessive current can be suppressed at the start time of the rotation of the motor in the forward rotation direction and in the reverse rotation direction. In particular, since the duty ratio of the PWM control is increased gradually from 0% immediately after the rotation direction of the motor is switched, the starting characteristics of the motor can be stabilized. Furthermore, after the duty ratio being increased has reached the limit value, the motor is driven during the predetermined period while the limit value remains unchanged, whereby it is possible to suppress excessive current from flowing through the motor.

(13) In a thirteenth aspect, there is provided the impact tool according to the twelfth aspect, further comprising a control section for controlling the rotation of the motor, wherein the control section causes the hammer to be continuously driven in the forward rotation direction after a trigger is pulled, and wherein the control section performs an intermittent drive control, in which the hammer is rotated in the reverse rotation direction and in the forward rotation direction, after a change rate of the rotation angle of the hammer that is continuously driven in the forward rotation direction becomes less than a predetermined value.

According to the thirteenth aspect, at the time of a low load state before a bolt or the like is seated, the anvil is rotated continuously, whereby an object to be tightened can be tightened quickly. Furthermore, the seating state can be detected with a high degree of accuracy, whereby the continuous drive control can be quickly shifted to the intermittent drive control.

(14) In a fourteenth aspect, there is provided the impact tool according to the thirteenth aspect, wherein the control section controls the duty ratio for driving the motor such that the duty ratio is limited during a period t_{Drim} after the switching of the rotation direction of the hammer and the duty ratio increases gradually after the period t_{Drim} has passed.

According to the fourteenth aspect, the rotation speed of the motor can be adjusted properly.

(15) In a fifteenth aspect, there is provided the impact tool according to the fourteenth aspect, wherein the period during which the duty ratio is limited is equal to or less than half of a forward drive period or half of a reverse drive period of the motor.

According to the fifteenth aspect, the motor can be accelerated to its target rotation speed quickly without significantly degrading the acceleration performance of the motor.

(16) In a sixteenth aspect, there is provided the impact tool according to the fifteenth aspect, wherein the duty ratio is limited to 50% or less during the period during which the duty ratio is limited.

According to the sixteenth aspect, the starting current flowing through the motor can be prevented effectively from increasing excessively.

(17) In a seventeenth aspect, there is provided the impact tool according to any one of the twelfth to sixteenth aspects, wherein, during the intermittent drive control, a reverse rotation angle or a forward rotation angle of the hammer is detected by using a signal indicating rotation position of the motor.

According to the seventeenth aspect, the rotation position of the hammer can be detected accurately using the outputs of the existing rotation position detecting devices without additionally providing rotation position detecting means for the hammer.

(18) In an eighteenth aspect, there is provided the impact tool according to the seventeenth aspect, wherein the hammer is connected to the motor via a speed reducing mechanism, and wherein the forward rotation angle and the reverse rotation angle of the hammer are calculated by multiplying the rotation angle of the motor by the reduction ratio of the speed reducing mechanism.

According to the eighteenth aspect, the rotation position of the hammer can be detected at accuracy far higher than the rotation angle detection accuracy of the rotor.

What is claimed is:

1. An impact tool comprising:
a motor including,
a rotor,
a stator, and
a detecting device that detects a rotation position of the rotor;
a hammer driven by the motor so as to be rotated;
an anvil configured to rotate relatively to the hammer and is struck by the hammer; and
an output shaft connected to the anvil;
wherein the anvil is struck by the hammer by rotating the hammer in a forward rotation direction by a second predetermined amount after rotating the hammer in a reverse rotation direction by a first predetermined amount, and
wherein the first predetermined amount and the second predetermined amount are controlled based on a rotation angle that is obtained based on an output of the detecting device.

2. The impact tool according to claim 1, further comprising a control section for controlling the rotation of the motor,
wherein the control section starts an intermittent drive control, in which the hammer is rotated in the reverse rotation direction and in the forward rotation direction, after a change rate of the rotation angle of the hammer that is continuously driven in the forward rotation direction becomes less than a predetermined value.

3. The impact tool according to claim 2,
wherein the control section stores a reverse rotation start position of the hammer, which is a position where the hammer starts the reverse rotation, rotates the hammer in the reverse rotation direction and then in the forward rotation direction, and stops supply of a forward rotation drive voltage to the motor after the hammer has reached an area near the reverse rotation start position again.

4. The impact tool according to claim 3,
wherein a reverse rotation angle and a forward rotation angle of the rotor are calculated in order to detect that the hammer has reached the area near the reverse rotation start position.

5. The impact tool according to claim 1,
wherein the hammer is connected to the motor via a speed reducing mechanism, and
wherein a forward rotation angle and a reverse rotation angle of the hammer are calculated by multiplying the rotation angle of the motor by a reduction ratio of the speed reducing mechanism.

6. An impact tool comprising:
a motor;
a hammer connected to the motor;
an anvil rotated by the hammer; and
a control section for controlling rotation of the motor,
wherein the hammer strikes the anvil so as to rotate the anvil, and
wherein the control section stops supply of a drive voltage to the motor near a timing when the hammer strikes the anvil.

7. The impact tool according to claim 6,
wherein the control section causes the hammer to strike the anvil and to rotate the anvil by rotating the hammer alternately in a forward rotation direction and in a reverse rotation direction.

8. The impact tool according to claim 7,
wherein, before the hammer strikes the anvil, the motor is rotated by inertia.

9. The impact tool according to claim 7,
wherein the supply of the drive voltage to the motor is stopped when the hammer strikes the anvil.

10. The impact tool according to claim 8,
wherein the rotation angle of the hammer is detected by using an output of a sensor for detecting a rotation position of the motor, and
wherein the hammer is controlled to be rotated in the forward rotation direction by an angle equal to or slightly less than a predetermined angle after the hammer has been rotated in the reverse rotation direction by the predetermined angle.

11. The impact tool according to claim 10,
wherein the motor is connected to the hammer via gears, and a rotation speed of the motor is higher than a rotation speed of the hammer.

12. An impact tool comprising:
a motor;
a hammer driven by the motor so as to be rotated;
an anvil configured to rotate relatively to the hammer and is struck by the hammer; and
an output shaft connected to the anvil,
wherein the anvil is struck by the hammer by rotating the hammer in a forward rotation direction by a second predetermined amount after rotating the hammer in a reverse rotation direction by a first predetermined amount, and
wherein a duty ratio of pulse-width modulation control is limited during a predetermined period immediately after a rotation direction of the motor is switched to rotate the hammer in the reverse rotation direction or in the forward rotation direction such that the duty ratio of the pulse-width modulation control gradually increases from 0%, and after the duty ratio has reached a limit value, the motor is driven during the predetermined period at a duty ratio of the limited value.

13. The impact tool according to claim 12, further comprising a control section for controlling the rotation of the motor,
wherein the control section causes the hammer to be continuously driven in the forward rotation direction after a trigger is pulled, and
wherein the control section performs an intermittent drive control, in which the hammer is rotated in the reverse rotation direction and in the forward rotation direction, after a change rate of the rotation angle of the hammer that is continuously driven in the forward rotation direction becomes less than a predetermined value.

14. The impact tool according to claim 13,
wherein the control section controls the duty ratio for driving the motor such that the duty ratio is limited during a period t_{Drim} after the switching of the rotation direction of the hammer and the duty ratio increases gradually after the period t_{Drim} has passed.

15. The impact tool according to claim 14,
wherein the period during which the duty ratio is limited is equal to or less than half of a forward drive period or half of a reverse drive period of the motor.

16. The impact tool according to claim 15,
wherein the duty ratio is limited to 50% or less during the period during which the duty ratio is limited.

17. The impact tool according to claim 12,
wherein, during the intermittent drive control, a reverse rotation angle or a forward rotation angle of the hammer is detected by using a signal indicating rotation position of the motor.

18. The impact tool according to claim 17,
wherein the hammer is connected to the motor via a speed reducing mechanism, and
wherein the forward rotation angle and the reverse rotation angle of the hammer are calculated by multiplying the rotation angle of the motor by the reduction ratio of the speed reducing mechanism.
